(19) United States
(12) Patent Application Publication
(10) Pub. No.: US 2017/0017955 A1
(43) Pub. Date: Jan. 19, 2017

(54) Point-to-Point Transaction Guidance Apparatuses, Methods and Systems

(71) Applicant: FMR LLC, Boston, MA (US)

(72) Inventors: Hadley Rupert Stern, West Newton, MA (US); John C. McDonough, Nahant, MA (US); Dmitry Bisikalo, Framingham, MA (US); Suzanne K. Mcdonough, Nahant, MA (US); Alexander Charles Gavis, Wellesley Hills, MA (US); Matthew Ryan George, Boston, MA (US)

(21) Appl. No.: 14/799,242

(22) Filed: Jul. 14, 2015

(51) Int. Cl. G06Q 20/36; H04W 4/02; G06Q 20/32

(52) U.S. Cl. CPC G06Q 20/36; G06Q 20/325; H04W 4/02

(57) ABSTRACT

The Point-to-Point Transaction Guidance Apparatuses, Methods and Systems (“P2PTG”) transforms virtual wallet address inputs via P2PTG components into transaction confirmation outputs. In one embodiment, the P2PTG includes a point-to-point payment guidance apparatus, comprising, a memory and processor disposed in communication with the memory, and configured to issue a plurality of processing instructions from the component collection stored in the memory, to: obtain a target wallet identifier registration at a beacon. The P2PTG then may register the target wallet identifier with the beacon and obtain a unique wallet identifier from a migrant wallet source associated with a user at the beacon. The P2PTG may then obtain a target transaction request at the beacon from the migrant wallet source and commit the target transaction request for the amount specified in the target transaction request to a distributed block chain database configured to propagate the target transaction request across a distributed block chain database network for payment targeted to the target wallet identifier registered at the beacon.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address Guided Target Transactions, and more particularly, include Point-to-Point Transaction Guidance Apparatuses, Methods and Systems.

As such, the present innovations include (at least) the following distinct areas, including: Electrical Communications with Selective Electrical Authentication of Communications (with a suggested Class/Subclass of 340/5.8); Data Processing Using Cryptography for Secure Transactions including Transaction Verification and Electronic Credentials (with a suggested Class/Subclass of 705/64, 74, 75); and Electronic Funds Transfer with Protection of Transmitted Data by Encryption and Decryption (with a suggested Class/Subclass of 902/2).

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. §112.

### BACKGROUND

Bitcoin is the first successful implementation of a distributed crypto-currency. Bitcoin is more correctly described as the first decentralized digital currency. It is the largest of its kind in terms of total market value and is built upon the notion that money is any object, or any sort of record, accepted as payment for goods and services and repayment of debts. Bitcoin is designed around the idea of using cryptography to control the creation and transfer of money. Bitcoin enables instant payments to anyone, anywhere in the world. Bitcoin uses peer-to-peer technology to operate with no central authority. Transaction management and money issuance are carried out collectively by the network via consensus.

Bitcoin is an open source software application and a shared protocol. It allows users to anonymously and instantaneously transact Bitcoin, a digital currency, without needing to trust counterparties or separate intermediaries. Bitcoin achieves this trustless anonymous network using public/private key pairs, a popular encryption technique.

### BRIEF DESCRIPTION OF THE DRAWINGS

Appendices and/or drawings illustrating various, non-limiting, example, innovative aspects of the Point-to-Point Transaction Guidance Apparatuses, Methods and Systems (hereinafter “P2PTG”) disclosure, include:

FIG. 1 shows a block diagram illustrating embodiments of a network environment including the P2PTG;

FIG. 2 shows a block diagram illustrating embodiments of a network environment including the P2PTG;

FIG. 3 shows a block diagram illustrating embodiments of a network nodes of the P2PTG

FIG. 4 shows a datagraph diagram illustrating embodiments of a login process for the P2PTG;

FIG. 5 shows a datagraph illustrating embodiments of a transaction for the P2PTG;

FIG. 6 shows a flowchart of a blockchain generation process for the P2PTG;

FIG. 7 shows a flowchart of a blockchain auditing process for the P2PTG;

FIG. 8 shows a flowchart of a virtual currency transaction process for the P2PTG;

FIG. 9 shows a Bluetooth or NFC-enabled environment for enabling a P2PTG transaction;

FIG. 10 shows a flowchart of a Bluetooth payment process for the P2PTG;

FIG. 11 shows a flowchart of a Bluetooth inter-party payment process for the P2PTG;

FIG. 12 shows a flowchart of a verified payment process for the P2PTG;

FIG. 13 shows a flowchart of a meter reading process for the P2PTG;

FIG. 14 shows a flowchart of a resource monitoring process for the P2PTG;

FIG. 15 shows a flowchart of a micropayment button payment process for the P2PTG;

FIG. 16 shows a flowchart of a personnel tracking process for the P2PTG;

FIG. 17 shows a flowchart of a voting process for the P2PTG; and

FIG. 18 shows a block diagram illustrating embodiments of a controller.

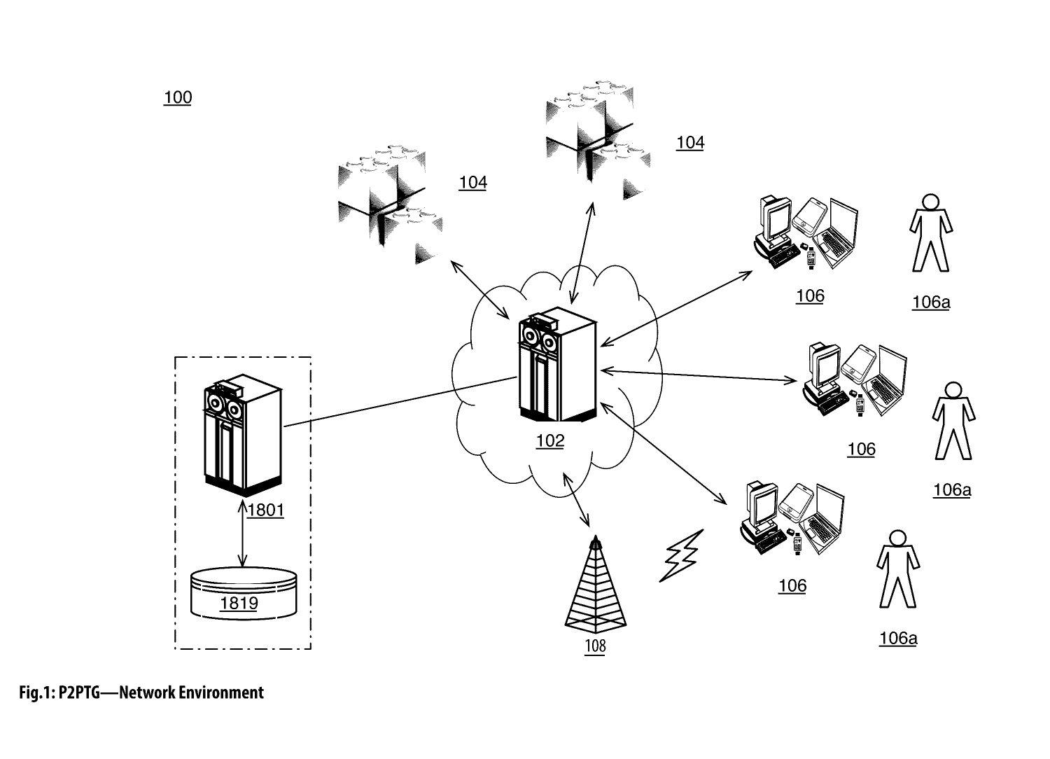

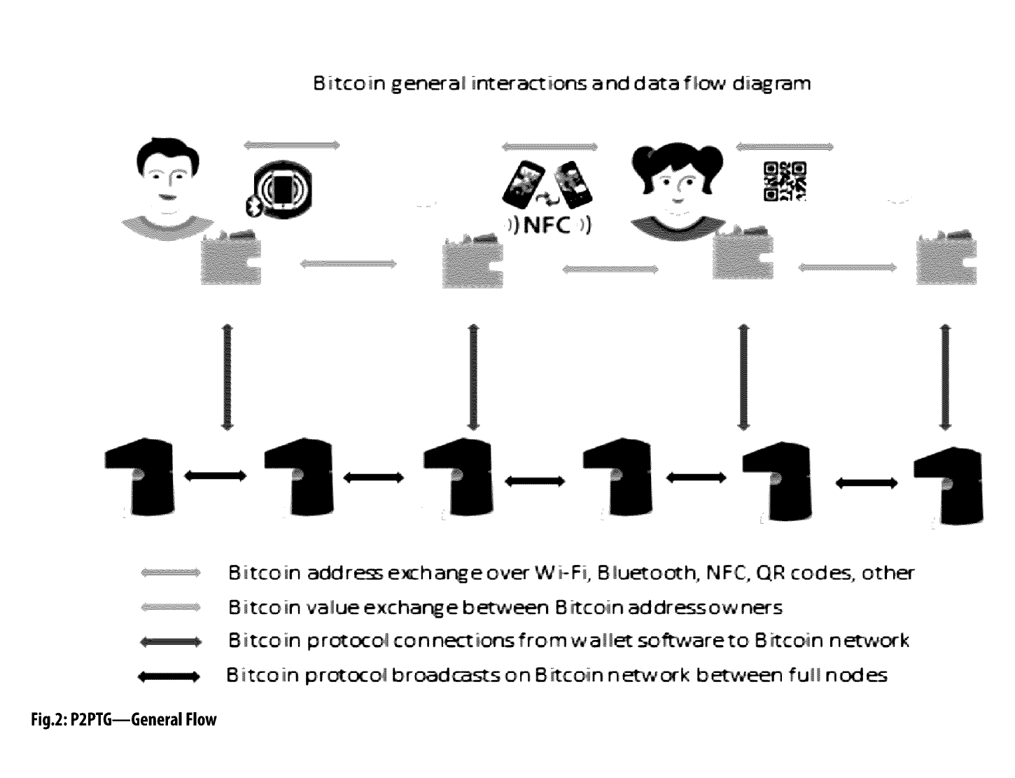

Generally, the leading number of each citation number within the drawings indicates the figure in which that citation number is introduced and/or detailed. As such, a detailed discussion of citation number 101 would be found and/or introduced in FIG. 1. Citation number 201 is introduced in FIG. 2, etc. Any citation and/or reference numbers are not necessarily sequences but rather just example orders that may be rearranged and other orders are contemplated.

### DETAILED DESCRIPTION

The Point-to-Point Transaction Guidance Apparatuses, Methods and Systems (hereinafter “P2PTG”) transforms virtual wallet address inputs, via components (e.g., Virtual Currency Component, Blockchain Component, Transaction Confirmation Component, etc.), into transaction confirmation outputs. The components, in various embodiments, implement advantageous features as set forth below.

### Introduction

Bitcoin transactions are typically posted on a public, distributed ledger called a blockchain. The Bitcoin network stores complete copies of the blockchain on nodes that are distributed around the world. Anyone can install the Bitcoin software on a networked computer to begin running a node. Because the blockchain is public, anyone can see the complete history of Bitcoin transactions and the public addresses that are currently “storing” Bitcoin.

In order to move Bitcoin between public addresses, a user must prove that he owns the sending address that is storing the Bitcoin to be sent, and know the receiving address where the Bitcoin is to be transferred.

Before Bitcoin can be transferred out of a public address, the owner of that address must prove that he owns the address by signing the transaction with the same private key that was used to generate the public address. Upon successfully doing so, the transaction is then broadcast to the Bitcoin network. The network groups transactions into blocks, confirms that the transactions are valid, and adds the block to the blockchain.

Bitcoin as a form of payment for products and services has grown, and merchants have an incentive to accept it because fees are lower than the 2-3% typically imposed by credit card processors. Unlike credit cards, any fees are paid by the purchaser, not the vendor. The European Banking Authority and other authorities have warned that, at present, Bitcoin users are not protected by refund rights or an ability to obtain chargebacks with respect to fraudulent or erroneous transactions. These and other limitations in the previous implementation of Bitcoin are now readily overcome.

### Uses

One possible non-monetary implementation for the P2PTG is as a shared (virtual) ledger used to monitor, track and account for actual people that may go missing. Social media systems could use P2PTG as a more secure and flexible way to keep track of people, identities and personas.

Using a P2PTG as a way to store the identities will enable broad access to authorized users and can be implemented in a publicly-available way. Each and every addition or deletion to the ledger of identities will be traceable and viewable within the P2PTG's Blockchain ledger.

This can be done by defining a few fields, with size and other attributes, publicly sharing the definition and allowing those skilled in the art to access and update, delete, change entries via tracing and auditing.

Implementations such as this could be used, for example with universities or governments and allow greater transparency. For instance, imagine there is a migration of peoples out of one country, say, in response to war or natural disaster. Typically, in historical cases there has been no feasible way to quickly track migrants during their relocation. A non-governmental organization (NGO) could use P2PTG to create a Blockchain ledger of all lost or displaced persons and that ledger could be used to track them through resettlement. The ledger could be referenced by individuals who could compare their credentials with those that are encrypted and stored through the ledger at a specific time and date in a Bitcoin-like format.

The P2PTG system could also be used for voting in places where there may not be well developed voting tabulation systems and where voting tallies are suspect. For example, it can be used to build a voting system in a developing country. By using the blockchain technology, an immutable ledger is created that records the votes of each citizen. The record would allow for unique identification of each voting individual and allow for tabulation of votes. One could easily tell if people actually voted, for whom they voted, and confirms that no one voted twice. A virtual fingerprinting or other biometrics could be added to the ledger to help avoid fraud, as described herein in more detail with respect to additional embodiments.

P2PTG may also be used for Proxy Voting for stocks or Corporations Annual Meetings that have questions put to a vote or for directors. The Blockchain adds transparency, speed and access to the information—and it can be verified and interrogated by many people. Accordingly, no one source needs to be trusted, as anyone in the public can see the ledger.

In underdeveloped areas the transport method could easily be 3G\LTE\4G with TCP\IP or other protocols used to transport the messages from a remote area, serviced by Mobile phone service—to the cloud where the accessible, shared Blockchain ledgers are maintained and made publicly available.

Implementations for better tracking of usage of resources can be enabled through the P2PTG. For example, water meters, electric & gas meters, as well as environmental monitoring devices such as C02 emitter meters can be used to inform enable a Bitcoin-style transaction involving resource usage or pollution emission. Using measurement devices that track the usage of these household resources or industrial pollutants, a Bitcoin-enabled marketplace between individuals, corporations and government entities can be created.

Suppose Alex lives in a community or state that taxes greenhouse gases. By using the P2PTG, both government waste as well as friction in the financial system can be mitigated. Alex may instantly receive a credit or a surcharge based on his use of resources. Micro transactions, which are not practical today because of the relatively high transaction costs, are easily accommodated as P2PTG-enabled transactions, on the other hand, and can be moved daily, hourly or weekly with little transaction overhead.

For example, Alex makes a payment via P2PTG that can be placed on the block chain for the tax amount due, but which may not be valid until a certain date (e.g. end of the month). When the transaction becomes valid, Bitcoin-like virtual currency is transferred to the town treasury and the town immediately credits some amount back, based on the meter reading.

Alex may have a $500 carbon surcharge on his taxes today. The monitors on Alex's furnace, his gas meter and electric meter can sum up all his uses resulting in carbon emissions and then net them out—all using the blockchain. Then because the blockchain is accessible by his local town he can get the surcharged reduced by, for example, $250 per year in response to Alex's environmentally-friendly actions. Whereas in previous systems, Alex would have had to write out a check and mail it in, now, with P2PTG, a simple entry in the blockchain is created, read by the town hall and a corresponding entry is made in the town hall ledger. By moving virtual currency between the two ledgers (could be the same ledger but different accounts) we have “monies” moved without the mailing of a check, without the meter reader coming by, and without the bank processing as in prior systems.

Much like in home uses of P2PTG, the P2PTG may create a new paradigm for costs and billings of hotels, residences, dormitories, or other housings and lodgings having resources that are metered and billed to its occupants. The Blockchain may be used to track usage of resources such as water, electricity, TV charges, movie rentals, items taken from the refrigerator or mini-bar, heat and room temperature controls and the like. Hotel customers, resident, students or the like residing in individual or mass housing or lodging may then be credited or surcharged for their stay based on Bitcoin-enabled transactions and monitoring of their use of resources.

Monitors can be setup on appliances, heaters, a room by room water meter, and the like. The monitors can communicate with each other via Bluetooth, NFC, Wifi or other known means. Since low power consumption is generally preferred, the monitors may be coordinated by a single device in the room.

Through a hotel's use of P2PTG, a client may check in, get a room assignment and receive a virtual key to enter the assigned room. The virtual key may be sent to the client's P2PTG ledger, stored on his smartphone or other portable electronic device, and may be used to open the door when the phone is placed in proximity to the hotel room door lock, for example, where the smartphone or other device is Bluetooth or NFC-enabled and is in communication range of a corresponding reader in the room. This reader then connects with each measuring device for TV, heat, room service, water usage, etc. Throughout the client's stay, it tracks when the lights or air conditioning are left on, when in-room movies are rented, water usage for bath, sink and toilet and other chargeable room uses. A hotel client's bill upon check out can be reduced or enhanced with the hotel client's usage. Blockchain technology may also be used to record check-in and check-out times in order to more quickly free up the room to be rented again.

Also, P2PTG may be used to enable a seamless checkout process. When a client checks in, a smart contract is created to move Bitcoin-like virtual currency after his checkout date. Since the address that the client provides at the time of check-out might not contain enough funds as it did on check-in, the projected funds for this transaction may remain locked by the P2PTG, which can become valid and transferrable at a later time, i.e. upon check-out date. The hotel will immediately send credits or debits based on the actual usage of the hotel's amenities.

A consumer focused creation for P2PTG could be using a Bluetooth Beacon as a method for determining where to send a payment from a virtual currency wallet. The housekeeper could tag a hotel room with her Bluetooth beacon. A client staying in the room could use their mobile device to pick up that Beacon, receive a virtual id of the housekeeper, and transfer an amount to the virtual id as a tip. In the same manner, the P2PTG system could be used for the valet who retrieves the client's car, as well as other service providers at the hotel that may receive gratuities or the like.

Clients could also pay for Pay Per View Movies by Bluetooth/NFC sync and pay using their P2PTG wallet.

Currently the Bluetooth Beacon is of a size that does not physically allow all uses, but over time it will shrink in size and allow uses on many devices and many purposes. Paying the housekeeper, the dog walker, the valet, and possibly tipping your waitress. The blockchain technology provides many ways to pay someone without having to even talk to them and without the exchange of cash or credit card number, thus reducing the potential for fraud that commonly results from such transactions presently.

Another implementation of P2PTG is transactions involving a high value. For example, two persons which to make a face-to face transaction may meet in proximity of a Bluetooth beacon, where the Bluetooth or NFC chips in their respective electronic devices are matched. P2PTG can enable the transaction of a large sum of money and micro-payments from the P2PTG address of a payer to the P2PTG address of the payee via the Bluetooth beacon or NFC reader, while avoiding the transaction fees that may render such transactions traditionally infeasible.

Using alternative, electronic currencies supported by Blockchain technology, individuals can carry all the funds needed in a currency that is not susceptible to local changes—allowing the seller to get paid and transfer his monies back into dollars or another currency.

Another example is using a pre-built device that is used to order small amounts of relatively inexpensive items in a fast and convenient way. P2PTG could make these micro transactions feasible. For instance, a product or its packaging could include a button connected via Bluetooth or WiFi, Radio Frequencies or NFC (see, e.g., AMAZON DASH). This button could be re-usable and disposable. Once pushed the button will result in an order to a vendor or fulfillment house for a replacement of the individual product. On the back end, the shipping of the items could be aggregated through new or existing systems.

However, on the payment processing side there is an overhead percentage that must be paid to credit- or debit-payment processing facilities that facilitate a traditional currency-based transaction. When payment is made with virtual currency via P2PTG in place of traditional currency transaction, the actual transaction cost is much lower.

Unlike prior Bitcoin implementations, the P2PTG also provides a centralized source for transaction processing, clearance and auditing. AS such the operator of the P2PTG, for example, may collect transaction fees associated with use of the P2PTG network. The operator may also be a guarantor of the accuracy of the transactions, and may reimburse a user in case of fraud or erroneous processing.

### P2PTG

FIG. 1 shows a block diagram illustrating networked embodiments of the P2PTG.

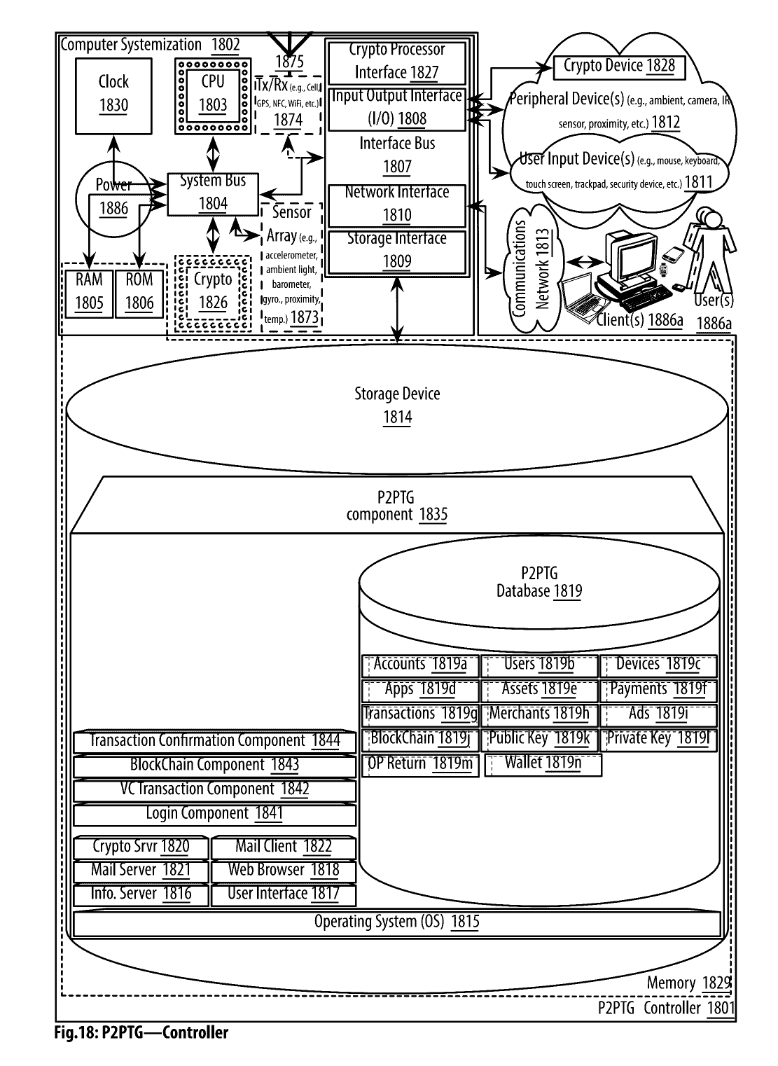

The network environment 100 may include a P2PTG Server 1801, the functions and components of which described in detail below with respect to FIG. 18. The P2PTG Server 1801 may comprise one or many servers, which may collectively be included in the P2PTG System.

The network environment 100 may further include a P2PTG Database 1819, which may be provided to store various information used by the P2PTG Server 1801 including client portfolio data, financial transaction data, and any other data as described, contemplated and used herein.

The network environment 100 may further include a Network Interface Server 102, which, for example, enables data network communication between the P2PTG Server 1801, Third Party Server(s) 104, wireless beacon 108 and Client Terminal(s) 106, in accordance with the interactions as described herein.

The one or more Client Terminals 106 may be any type of computing device that may be used by Clients 106a to connect with the P2PTG Server 1801 over a data communications network. Clients 106a, in turn, may be customers who hold financial accounts with financial or investing institutions, as described further herein.

The Third Party Server(s) 104 may be operated by any other party that is involved in a transaction. Accordingly, the third party server 104 may be any type of computing device described herein as may be operated by a vendor, a payment processor, an individual, a corporation, a government agency, a financial institution, and the like.

The wireless beacon 108 may be any type of wireless transceiver for relaying information between client devices 106 for sending or receiving payment information within a localized geographic area. Accordingly, the wireless beacon 108 may be Bluetooth, Near Field Communication (NFC), WiFi (such as IEEE 802.11) wireless routers, and the like.

The servers and terminals represented in FIG. 1 cooperate via network communications hardware and software to initiate the collection of data for use in the P2PTG system, the processes involving which will now be described in more detail.

FIG. 2 shows a second block diagram illustrating embodiments of a network environment including the P2PTG. This includes the interactions between various parties using the P2PTG system.

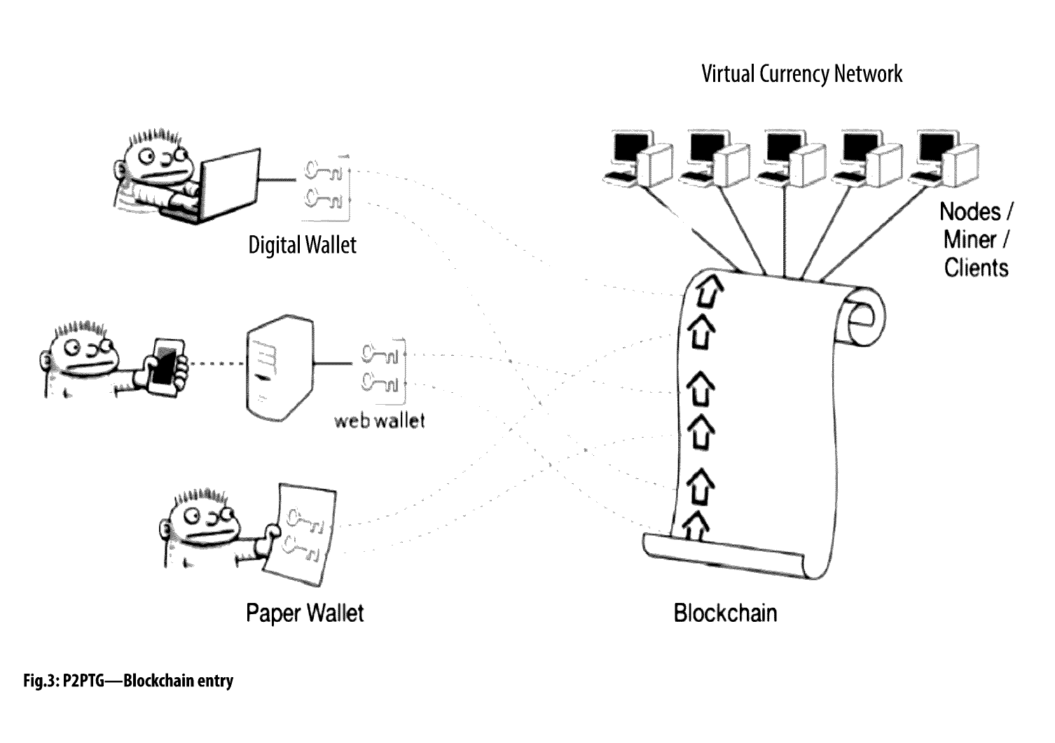

FIG. 3 shows a block diagram illustrating embodiments of network nodes of the P2PTG, in which virtual currency wallet transactions are recorded in Bitcoin-style blockchains.

Virtual currency users manage their virtual currency addresses by using either a digital or paper “wallet.” Wallets let users send or receive virtual currency payments, calculate the total balance of addresses in use, and generate new addresses as needed. Wallets may include precautions to keep the private keys secret, for example by encrypting the wallet data with a password or by requiring two-factor authenticated logins.

Virtual wallets provide the following functionality: Storage of virtual currency addresses and corresponding public/private keys on user's computer in a wallet.dat file; conducting transactions of obtaining and transferring virtual currency, also without connection to the Internet; and provide information about the virtual balances in all available addresses, prior transactions, spare keys. Virtual wallets are implemented as stand-alone software applications, web applications, and even printed documents or memorized passphrases.

Virtual wallets that directly connect to the peer-to-peer virtual currency network include bitcoind and Bitcoin-Qt, the bitcoind GUI counterparts available for Linux, Windows, and Mac OS X. Other less resource intensive virtual wallets have been developed, including mobile apps for iOS and Android devices that display and scan QR codes to simplify transactions between buyers and sellers. Theoretically, the services typically provided by an application on a general purpose computer could be built into a stand-alone hardware device, and several projects aim to bring such a device to market.

Virtual wallets provide addresses associated with an online account to hold virtual currency funds on the user's behalf, similar to traditional bank accounts that hold real currency. Other sites function primarily as real-time markets, facilitating the sale and purchase of virtual currency with established real currencies, such as US dollars or Euros. Users of this kind of wallet are not obliged to download all blocks of the block chain, and can manage one wallet with any device, regardless of location. Some wallets offer additional services. Wallet privacy is provided by the website operator. This “online” option is often preferred for the first acquaintance with a virtual currency system and short-term storage of small virtual currency amounts and denominations.

Any valid virtual currency address keys may be printed on paper, i.e., as paper wallets, and used to store virtual currency offline. Compared with “hot wallets”—those that are connected to the Internet—these non-digital offline paper wallets are considered a “cold storage” mechanism better suited for safekeeping virtual currency. It is safe to use only if one has possession of the printed the paper itself. Every such paper wallet obtained from a second party as a present, gift, or payment should be immediately transferred to a safer wallet because the private key could have been copied and preserved by a grantor.

Various vendors offer tangible banknotes, coins, cards, and other physical objects denominated in bitcoins. In such cases, a Bitcoin balance is bound to the private key printed on the banknote or embedded within the coin. Some of these instruments employ a tamper-evident seal that hides the private key. It is generally an insecure “cold storage” because one can't be sure that the producer of a banknote or a coin had destroyed the private key after the end of a printing process and doesn't preserve it. A tamper-evident seal in this case doesn't provide the needed level of security because the private key could be copied before the seal was applied on a coin. Some vendors will allow the user to verify the balance of a physical coin on their website, but that requires trusting that the vendor did not store the private key, which would allow them to transfer the same balance again at a future date before the holder of the physical coin.

To ensure safety of a virtual wallet in the P2PTG system, on the other hand, the following measures are implemented: wallet backup with printing or storing on flash drive in text editor without connection to Internet; encryption of the wallet with the installation of a strong password; and prudence when choosing a quality service.

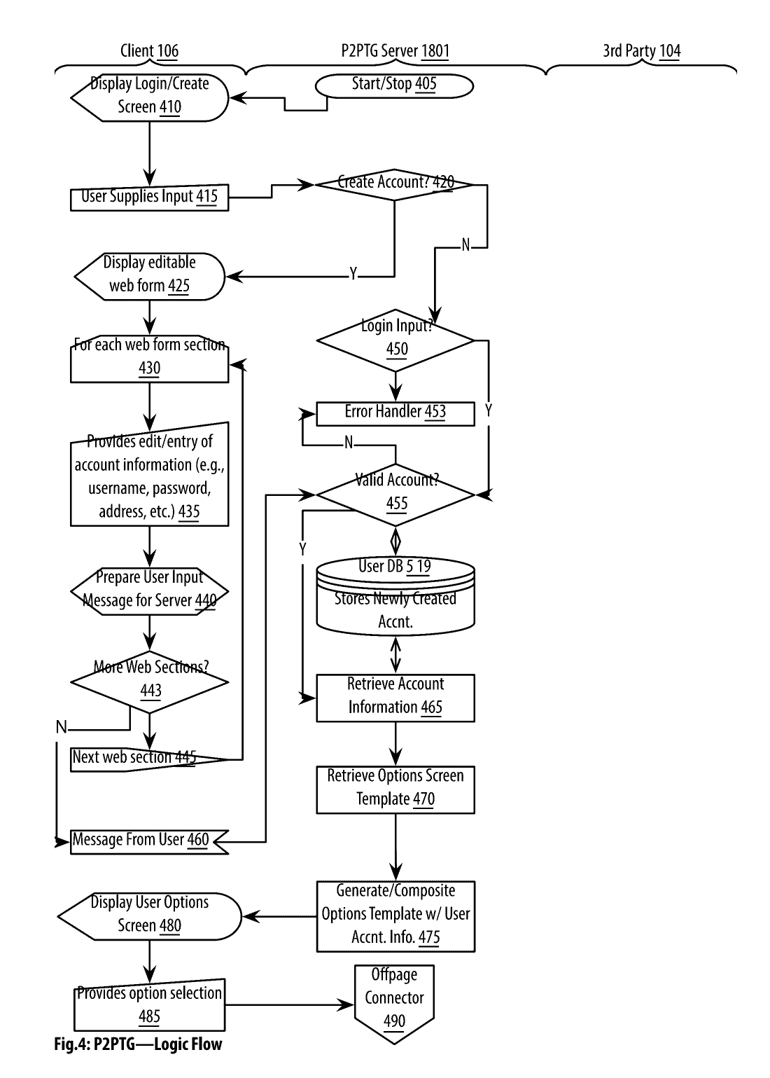

FIG. 4 shows a datagraph diagram illustrating embodiments of a login process for the P2PTG. Commencing at step 405, the P2PTG Controller 1801 responds to a user's (i.e., a recruiter's or candidate's) login request and displays a login/create account screen on the Client Terminal 106 (step 410). The user responsively enters an input (step 415) comprising either a login request to an existing account, or a request to create a new account. At step 420, if the user is requesting to create an account, the process continues to step 425 below. If instead, the user is requesting access to an existing account, the process continues to step 435 below.

When the user's entry comprises a request to create a new account, the P2PTG Controller 1801 prepares and transmits a web form and fields for creating a new account (step 425).

Next, at step 430, the user enters any requisite information in the displayed web form fields. Such web form may include fields for entering the user's full name, address, contact information, a chosen username, a chosen password and/or any other useful identification information to associate with the account (step 435). The user's inputs are then prepared for transmission to the P2PTG Controller 1801 (step 436). The Client Terminal 106 confirms whether there are more web sections or forms to complete (step 440). If so, the process returns to step 430 above. Otherwise, the process continues to step 460, where the entered account information is transmitted to the P2PTG Controller 1801 for storage in, for example, the maintained Account Database 1819a, as described in more detail later below.

From either step 420 or 460 above, the process continues to step 435, wherein the P2PTG Controller 1801 determines whether a login input has been received. If so, the process continues to step 455 below. Otherwise, the process continues to an error handling routine (step 441), wherein the user may be given a limited number of attempts to enter a login input that corresponds to a valid stored investment account. If no valid login is presented within the given number of allowed attempts, the user is denied access to the P2PTG Controller 1801.

At step 453, the P2PTG Controller 1801 determines whether a valid login input has been received, for example by comparing the received login input to data stored in the P2PTG Database 1819. If the received login credentials are valid, the process continues to step 465 below. Otherwise the process returns to step 441 above.

At step 465, when valid login credentials have been received from the Client Terminal 106, the P2PTG Controller 1801 retrieves account information appropriate for the user. Next, at step 470, the P2PTG Controller 1801 retrieves an options screen template based on the user, and then generates a composite options screen with the user's account information (step 475), which is transmitted to the client terminal 106 for display to a user on a display device thereof (step 480).

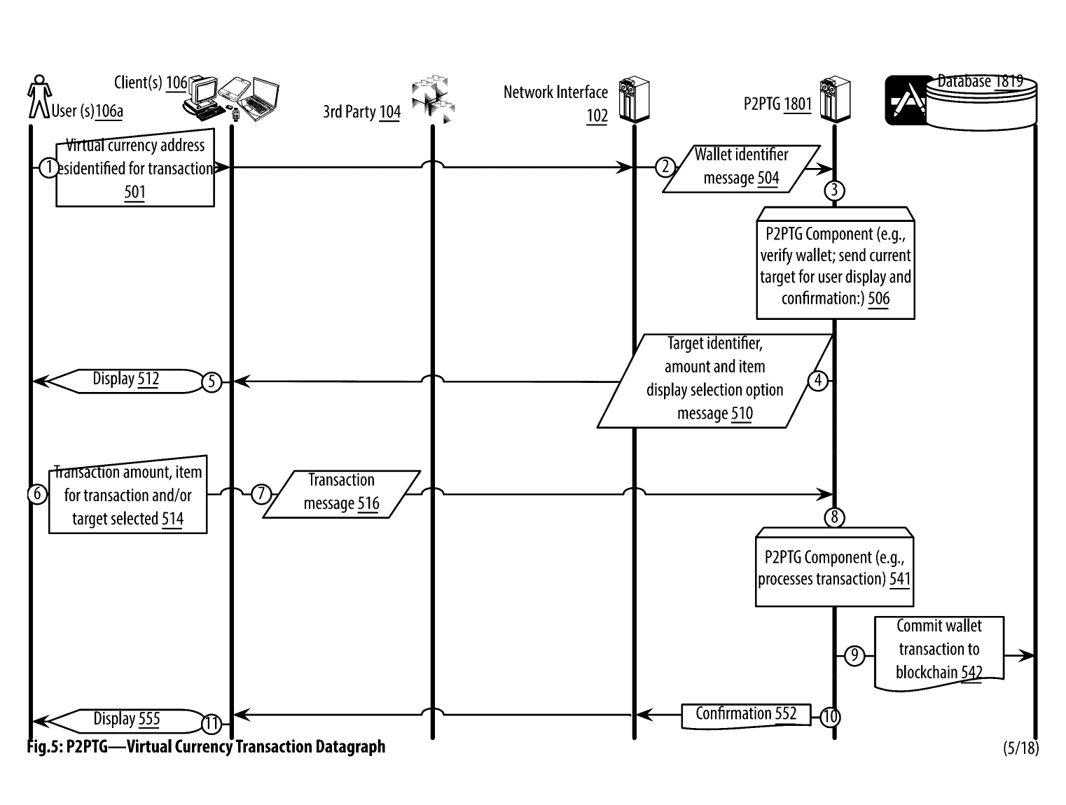

FIG. 5 shows a datagraph illustrating embodiments of a virtual currency transaction performed by the P2PTG. A user 106a may engage their client 106 such that their virtual wallet interacts with the P2PTG to affect a transfer of virtual currency to a third party. The third party may confirm the transaction via third-party device 104. In one example, the network interface 102 includes a beacon that may be attached to another device (e.g., a utility monitoring device, a consumable item, another mobile client device, a smartphone, computer, etc.). The beacon may provide a destination virtual currency address to which a transfer of virtual currency is to be completed. Alternatively, or in addition thereto, the third party device 104 may provide the destination address for a transaction in place of a beacon, according to the various implementations described herein. Likewise, the client may provide the destination address with the transaction request when it is otherwise known to the client 106. The network device 102 may be configured to enable network communication between at least one P2PTAG server 1801 and the client terminal 106 and/or third party device 104.

To commence a transaction, the client terminal 106 forwards a wallet identifier message (step 504) to the server 1801. In one embodiment, the P2PTG server may have instantiated a P2PTG component 1841, which in turn may verify that the wallet identifier is valid. In one embodiment, the P2PTG component will determine that the client's 106 unique identifying address matches and is a valid source of sufficient virtual currency and is properly associated with the wallet identifier (e.g., by checking with a blockchain database 1819j, a wallet database 1819n, and/or the like)(step 506). If the wallet identifier is a non-invalid identifier, the P2PTG may generate a user interface prompt to allow a user to specify a target for payment proceeds, a selection mechanism for the target (e.g., a person, organization, cause, etc.), an amount to pay (e.g., in various electronic and/or real currencies), an item specification for the transaction (e.g., goods, services, equities, derivatives, etc.). In one embodiment, the P2PTG will search a database to determine what target wallets are currently associated with the network device 104. For example, in one embodiment, a hotel cleaning employee may have registered a room, or a valet may have registered with a valet parking beacon, etc., and their digital wallet will be retrieved and an address therefrom specified as a target for a transaction. Upon generating the interface (e.g., by retrieving an HTML template from the P2PTG database and compositing retrieved information, etc.), the P2PTG server 1801 may provide the user's client 106 with an interaction interface message (step 510) (e.g., allowing the user to see the target payment/transaction identifier (e.g., hotel valet, and/or hotel organization name, etc.), specify and amount to pay (e.g., a tip amount), an item for transaction (e.g., a towel), and a mechanism to instantiate the transaction (e.g., a ‘pay’ button) for display (step 512). Upon obtaining inputs for these UI selection mechanisms (step 514), the network device 102 may further on the user's transaction message with selections (step 516) to the P2PTG server for transaction processing by the P2PTG component (step 541).

In one embodiment, the client may provide the following example guidance transaction request, substantially in the form of a (Secure) Hypertext Transfer Protocol (“HTTP(S)”) POST message including eXtensible Markup Language (“XML”) formatted data, as provided below:

```
POST /authrequest.php HTTP/1.1
Host: www.server.com
Content-Type: Application/XML
Content-Length: 667
<?XML version = ″1.0″ encoding = ″UTF-8″?>
<guidanceTransactionRequest>
  <timestamp>2020-12-31 23:59:59</timestamp>
  <user_accounts_details>
    <user_account_credentials>
      <user_name>JohnDaDoeDoeDoooe@gmail.com</account_name>
      <password>abc123</password>
      //OPTIONAL <cookie>cookieID</cookie>
      //OPTIONAL <digital_cert_link>www.mydigitalcertificate.com/
JohnDoeDaDoeDoe@gmail.com/mycertifcate.dc</digital_cert_link>
    //OPTIONAL <digital_certificate>_DATA_</digital_certificate>
    </user_account_credentials>
  </user_accounts_details>
  <client_details> //iOS Client with App and Webkit
      //it should be noted that although several client details
      //sections are provided to show example variants of client
      //sources, further messages will include only on to save
      //space
    <client_IP>10.0.0.123</client_IP>
    <user_agent_string>Mozilla/5.0 (iPhone; CPU iPhone OS 7_1_1 like Mac
OS X) AppleWebKit/537.51.2 (KHTML, like Gecko) Version/7.0 Mobile/11D201
Safari/9537.53</user_agent_string>
    <client_product_type>iPhone6,1</client_product_type>
    <client_serial_number>DNXXX1X1XXXX</client_serial_number>
    <client_UDID>3XXXXXXXXXXXXXXXXXXXXXXXXD</client_UDID>
    <client_OS>iOS</client_OS>
    <client_OS_version>7.1.1</client_OS_version>
    <client_app_type>app with webkit</client_app_type>
    <app_installed_flag>true</app_installed_flag>
    <app_name>P2PTG.app</app_name>
    <app_version>1.0 </app_version>
    <app_webkit_name>Mobile Safari</client_webkit_name>
    <client_version>537.51.2</client_version>
  </client_details>
  <client_details> //iOS Client with Webbrowser
    <client_IP>10.0.0.123</client_IP>
    <user_agent_string>Mozilla/5.0 (iPhone; CPU iPhone OS 7_1_1 like Mac
OS X) AppleWebKit/537.51.2 (KHTML, like Gecko) Version/7.0 Mobile/11D201
Safari/9537.53</user_agent_string>
    <client_product_type>iPhone6,1</client_product_type>
    <client_serial_number>DNXXX1X1XXXX</client_serial_number>
    <client_UDID>3XXXXXXXXXXXXXXXXXXXXXXXXD</client_UDID>
    <client_OS>iOS</client_OS>
    <client_OS_version>7.1.1</client_OS_version>
    <client_app_type>web browser</client_app_type>
    <client_name>Mobile Safari</client_name>
    <client_version>9537.53</client_version>
  </client_details>
  <client_details> //Android Client with Webbrowser
    <client_IP>10.0.0.123</client_IP>
    <user_agent_string>Mozilla/5.0 (Linux; U; Android 4.0.4; en-us; Nexus
S Build/IMM76D) AppleWebKit/534.30 (KHTML, like Gecko) Version/4.0 Mobile
Safari/534.30</user_agent_string>
    <client_product_type>Nexus S</client_product_type>
    <client_serial_number>YXXXXXXXXZ</client_serial_number>
    <client_UDID>FXXXXXXXXX-XXXX-XXXX-XXXX-XXXXXXXXXXXXX</client_UDID>
    <client_OS>Android</client_OS>
    <client_OS_version>4.0.4</client_OS_version>
    <client_app_type>web browser</client_app_type>
    <client_name>Mobile Safari</client_name>
    <client_version>534.30</client_version>
  </client_details>
  <client_details> //Mac Desktop with Webbrowser
    <client_IP>10.0.0.123</client_IP>
    <user_agent_string>Mozilla/5.0 (Macintosh; Intel Mac OS X 10_9_3)
AppleWebKit/537.75.14 (KHTML, like Gecko) Version/7.0.3
Safari/537.75.14</user_agent_string>
    <client_product_type>MacPro5,1</client_product_type>
    <client_serial_number>YXXXXXXXXZ</client_serial_number>
    <client_UDID>FXXXXXXXXX-XXXX-XXXX-XXXX-XXXXXXXXXXXXX</client_UDID>
    <client_OS>Mac OS X</client_OS>
    <client_OS_version>10.9.3</client_OS_version>
    <client_app_type>web browser</client_app_type>
    <client_name>Mobile Safari</client_name>
    <client_version>537.75.14</client_version>
  </client_details>
  <walletID>abc123456789</walletID>
  <walletType>source</walletType>
  <currencyType>Bitcoin</currencyType>
  <targetWalletID>xyz98876543</targetWalletID>
  <targetWalletConfirmed>TRUE</targetWalletConfirmed>
  <targetWalletIdentifierDisplayed>John Doe, Hotel Inc.
Valet</targetWalletIdentifierDisplayed>
  <transactionDescription1>Tip</transactionDescription1>
  <transactionDescription2>
    <item>Air Freshner</item>
    <itemManufacturer>Acme Freshner Inc.</itemManufacturer>
    <itemSerialNo>123456</itemSerialNo>
    <itemModelNo>abc123</itemModelNo>
    <itemPrice>$2.57</itemPrice>
    <currencyValue>0.01</currencyValue> //eg current bitcoin value
  </transactionDescription2>
</guidanceTransactionRequest>
```

In one embodiment, the P2PTG component 541 may then provide a commit transaction as between the target wallet identifier (e.g., the hotel valet) and the source wallet identifier (e.g., the initiating user 106) and eventually cause a blockchain entry of the transaction to be recorded (step 542). Thereafter, the P2PTG server 1801 may provide a confirmation message (step 552) to the client 106 for display (step 555).

An electronic coin may be a chain of digital signatures. Each owner transfers the coin to the next by digitally signing a hash of the previous transaction and the public key of the next owner and adding these to the end of the coin. A payee can verify the signatures to verify the chain of ownership. So, effectively if BTC0 is the previous transaction, the new transaction is:

Kp(Owner1)
hash := H(BTC0, Kp(Owner1))
S(hash,Ks(Owner0)), where
Kp(Owner1) is the public key fo the recipient (Owner1)
hash := H(BIC0, Kp(Owner1)) is the hash of the previous transaction together
with the public key of the recipient; and
S(hash,Ks(Owner0)) is the previously computed hash, signed with the private key
sender (Owner0).
Principle example of a Bitcoin transaction with 1 input and 1 output only
Input:
Previous tx: f5d8ee39a430901c91a5917b9f2dc19d6d1a0e9cea205b009ca73dd04470b9a6
Index: 0
scriptSig: 304502206e21798a42fae0e854281abd38bacd1aeed3ee3738d9e1446618c4571d10
90db022100e2ac980643b0b82c0e88ffdfec6b64e3e6ba35e7ba5fdd7d5d6cc8d25c6b241501
Output:
Value: 5000000000
scriptPubKey: OP_DUP OP_HASH160 404371705fa9bd789a2fcd52d2c580b65d35549d
OP_EQUALVERIFY OP_CHECKSIG

The input in this transaction imports 50 denominations of virtual currency from output #0 for transaction number the transaction number starting with character f5d8 . . . above. Then the output sends 50 denominations of virtual currency to a specified target address (expressed here in hexadecimal string starting with 4043 . . . ). When the recipient wants to spend this money, he will reference output #0 of this transaction as an input of his next transaction.

An input is a reference to an output from a previous transaction. Multiple inputs are often listed in a transaction. All of the new transaction's input values (that is, the total coin value of the previous outputs referenced by the new transaction's inputs) are added up, and the total (less any transaction fee) is completely used by the outputs of the new transaction. According to blockchain technology, a transaction is a hash of previous valid transaction strings. Index is the specific output in the referenced transaction. ScriptSig is the first half of a script (discussed in more detail later).

The script contains two components, a signature and a public key. The public key must match the hash given in the script of the redeemed output. The public key is used to verify the redeemer's or payee's signature, which is the second component. More precisely, the second component may be an ECDSA signature over a hash of a simplified version of the transaction. It, combined with the public key, proves the transaction created by the real owner of the address in question. Various flags define how the transaction is simplified and can be used to create different types of payment.

Two consecutive SHA-256 hashes are used for transaction verification. RIPEMD-160 is used after a SHA-256 hash for virtual currency digital signatures or “addresses.” A virtual currency address is the hash of an ECDSA public-key, which may be computed as follows:

Key hash = Version concatenated with RIPEMD-160 (SHA-256 (public
key))
Checksum = 1st 4 bytes of SHA-256 (SHA-256 (Key hash))
Bitcoin address = Base58Encode (Key hash concatenated with Checksum)

The virtual currency address within a wallet may include an identifier (account number), for example, starting with 1 or 3 and containing 27-34 alphanumeric Latin characters (except, typically: 0, O, I, and 1 to avoid possible confusion). The address can be also represented as the QR-code and is anonymous and does not contain information about the owner. It can be obtained for free, using P2PTG.

The ability to transact virtual currency without the assistance of a central registry is facilitated in part by the availability of a virtually unlimited supply of unique addresses, which can be generated and disposed of at will. The balance of funds at a particular address can be ascertained by looking up the transactions to and from that address in the block chain. All valid transfers of virtual currency from an address are digitally signed using the private keys associated with it.

A private key in the context of virtual currency is a secret number that allows denominations of the virtual currency to be spent. Every address within a wallet has a matching private key, which is usually saved in the wallet file of the person who owns the balance, but may also be stored using other means and methods. The private key is mathematically related to the address, and is designed so that the address can be calculated from the private key while, importantly, the reverse cannot be done.

An output contains instructions for sending virtual currency. ScriptPubKey is the second half of a script. There can be more than one output that shares the combined value of the inputs. Because each output from one transaction can only ever be referenced once by an input of a subsequent transaction, the entire combined input value needs to be sent in an output to prevent its loss. If the input is worth 50 coins but one only wants to send 25 coins, P2PTG will create two outputs worth 25 coins, sending one to the destination and one back to the source. Any input not redeemed in an output is considered a transaction fee, and whoever operates the P2PTG will get the transaction fee, if any.

To verify that inputs are authorized to collect the values of referenced outputs, P2PTG uses a custom scripting system. The input's scriptSig and the referenced output's scriptPubKey are evaluated in that order, with scriptPubKey using the values left on the stack by scriptSig. The input is authorized if scriptPubKey returns true. Through the scripting system, the sender can create very complex conditions that people have to meet in order to claim the output's value. For example, it's possible to create an output that can be claimed by anyone without any authorization. It's also possible to require that an input be signed by ten different keys, or be redeemable with a password instead of a key.

P2PTG transactions create two different scriptSig/scriptPubKey pairs. It is possible to design more complex types of transactions, and link them together into cryptographically enforced agreements. These are known as Contracts.

An exemplary Pay-to-PubkeyHash is as follows:

scriptPubKey: OP_DUP OP_HASH160 <pubKeyHash> OP_EQUALVERIFY OP_CHECKSIG
scriptSig: <sig> <pubKey>

An address is only a hash, so the sender can't provide a full public key in scriptPubKey. When redeeming coins that have been sent to an address, the recipient provides both the signature and the public key. The script verifies that the provided public key does hash to the hash in scriptPubKey, and then it also checks the signature against the public key.

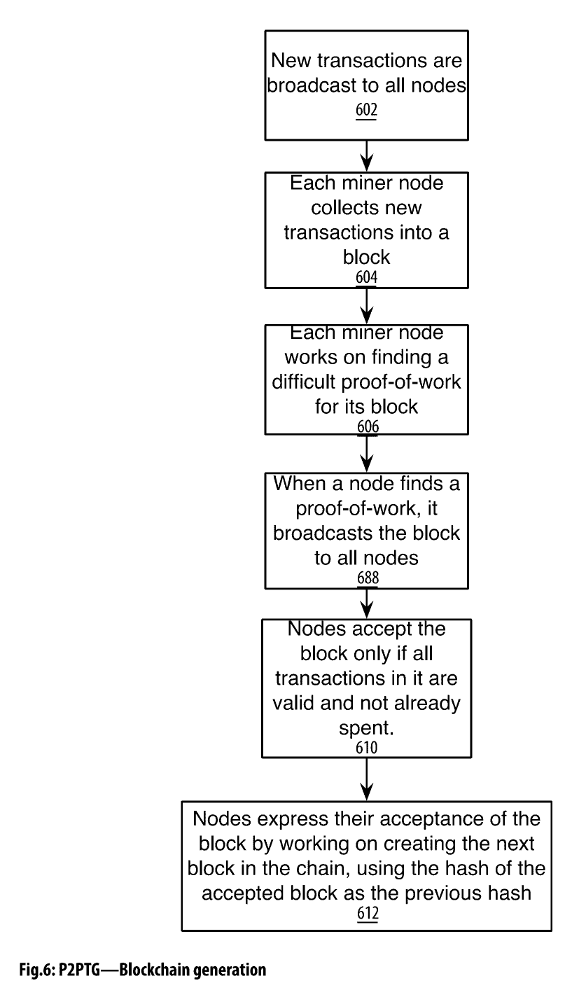

FIG. 6 shows a flowchart of a blockchain generation process for the P2PTG. New transactions are broadcast to all nodes (step 602). Each miner node collects new transactions into a block (step 604). Each miner node works on finding a difficult proof-of-work for its block (step 606). When a node finds a proof-of-work, it broadcasts the block to all nodes (step 608). Nodes accept the block only if all transactions in it are valid and not already spent (step 610). Nodes express their acceptance of the block by working on creating the next block in the chain, using the hash of the accepted block as the previous hash (step 612).

Transaction confirmation is needed to prevent double spending of the same money. After a transaction is broadcast to the P2PTG network, it may be included in a block that is published to the network. When that happens it is said that the transaction has been mined at a depth of one block. With each subsequent block that is found, the number of blocks deep is increased by one. To be secure against double spending, a transaction should not be considered as confirmed until it is a certain number of blocks deep. This feature was introduced to protect the system from repeated spending of the same coins (double-spending). Inclusion of transaction in the block happens along with the process of mining.

The P2PTG server 1801 may show a transaction as “unconfirmed” until the transaction is, for example, six blocks deep in the blockchain. Sites or services that accept virtual currency as payment for their products or services can set their own limits on how many blocks are needed to be found to confirm a transaction. However, the number six was specified deliberately. It is based on a theory that there's low probability of wrongdoers being able to amass more than 10% of entire network's hash rate for purposes of transaction falsification and an insignificant risk (lower than 0.1%) is acceptable. For offenders who don't possess significant computing power, six confirmations are an insurmountable obstacle with readily accessible computing technology. In their turn people who possess more than 10% of network power aren't going to find it hard to get six confirmations in a row. However, to obtain such a power would require millions of dollars' worth of upfront investments, which significantly defers the undertaking of an attack. Virtual currency that is distributed by the network for finding a block can only be used after, e.g., one hundred discovered blocks.

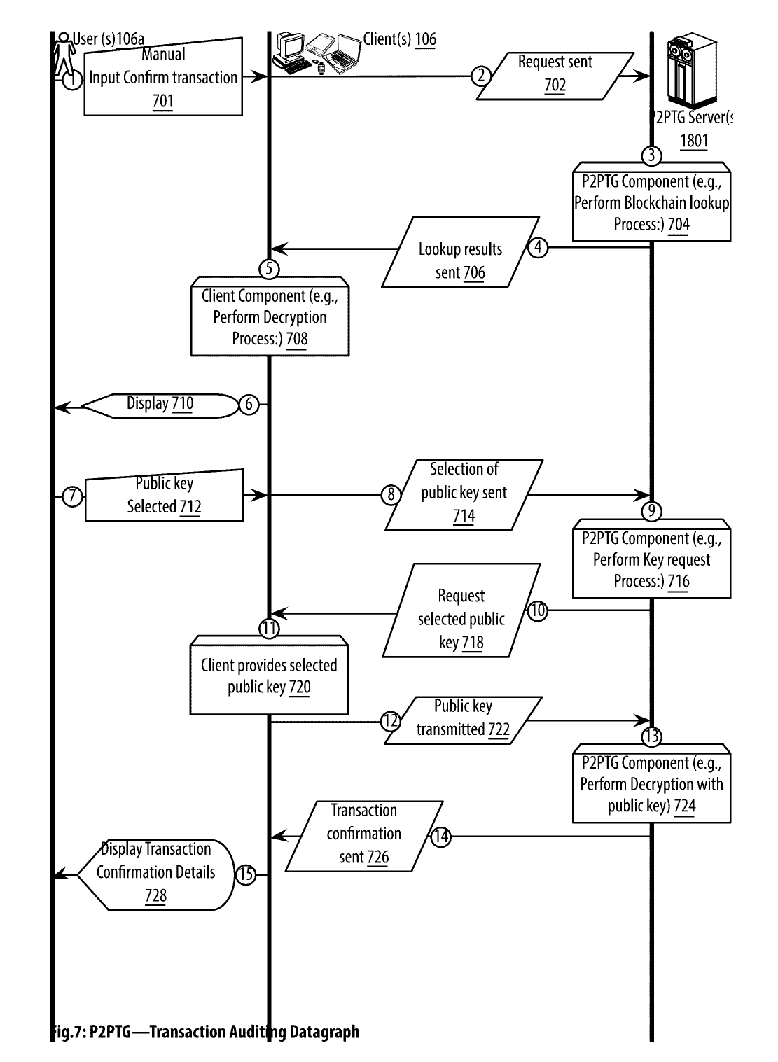

FIG. 7 shows a flowchart of a blockchain auditing process for the P2PTG. The process commences when a client inputs a request to confirm a transaction (step 701). The client may select, enter, retrieve or otherwise provide a public key corresponding to the payer or payee of a transaction or transactions to be audited.

Next, the request is transmitted to the P2PTG (step 702). In response, the P2PTG Component performs a Blockchain lookup Process using the public key and other information provided (step 704).

The lookup results are then sent to client (step 706). The client next transmits a Decryption Process request (step 708). Responsively, a request to select a public key is displayed to the client (step 710) before the decryption process can commence.

Next, at step 712, the user inputs a selection of a stored public key. The selection of the public key is then sent to P2PTG (step 714). Responsively, the P2PTG Component performs a Key Comparison Request process (step 716). The P2PTG then requests the selected public key from the processor of the client 106 (step 718). The client 106 responsively retrieves the selected public key from a memory of the client 106 (step 720). The public key is then transmitted to the P2PTG (step 722). The P2PTG Component then decrypts the transaction record in the stored blockchain using the public key (step 724). The decryption results are transmitted to the client 106 (step 726), which, in turn, displays the transaction confirmation details to the user 106a on a display of the client 106 or the like (step 728). This auditing process then ends.

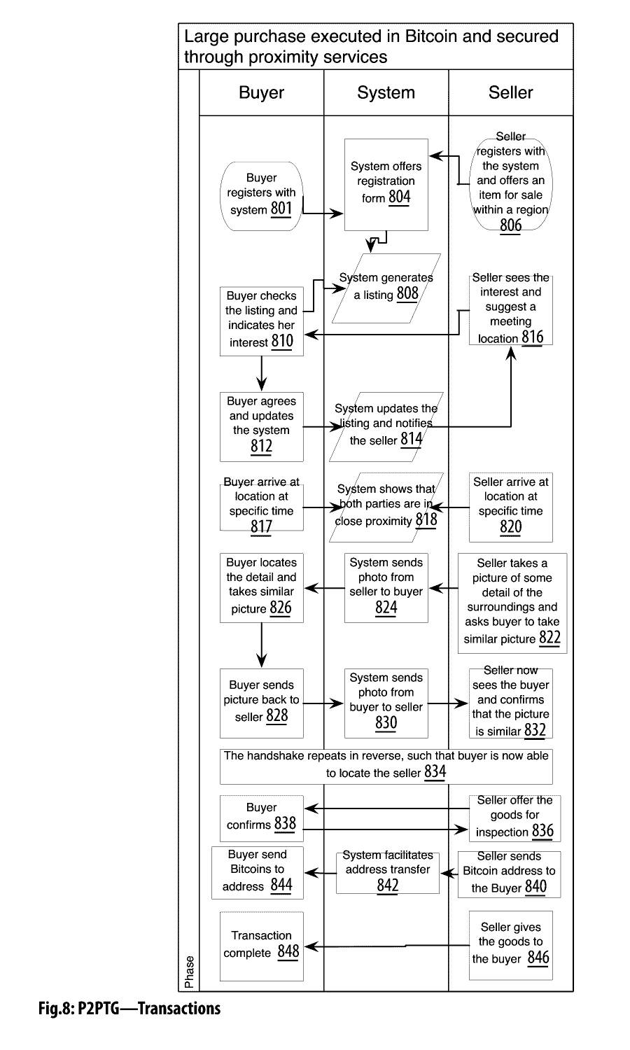

FIG. 8 shows a flowchart of a virtual currency transaction process between a buyer and a seller using the P2PTG. At a commencement of the process, a buyer (i.e., a payer) requests registration with the P2PTG system (step 801). In response, the P2PTG serves a registration form for completion by the buyer (step 804). The registration form may include an identification of the buyer, the buyers wallet, and a source of funds to be established in the wallet.

Likewise, a seller (i.e., a payee) registers with the system and offers an item for sale locally (step 806). The P2PTG may generate a listing for the seller's item that is accessible to other users of the P2PTG (step 808). Alternatively, or in addition thereto, the listing may provided at a physical or virtual location other than through the P2PTG. The buyer, at any later point, checks the listing and indicates her interest in the item (step 810). The P2PTG updates the listing and notifies the seller (step 814). The seller sees the interest and suggests a meeting location to the buyer via the P2PTG (step 816). The buyer agrees and notifies the seller via the P2PTG (step 812).

Next, the Buyer arrives at the agreed upon location at the designated time (step 817). Using a beacon or NFC, as described herein, or similar means, the P2PTG may be able to determine when both parties are in close proximity (step 818) and begin the transaction there-between, for example, on their respective portable electronic devices.

Alternatively, the buyer and seller may determine their proximity directly in any of a variety of manners. For example, the seller may arrive or otherwise be established or open at physical location at a specified time (step 820). Seller takes a picture of some detail of the surroundings and asks buyer to take a similar picture (step 822). The P2PTG sends the photo from the seller to the buyer (step 824). The buyer may then locate a detail in the received picture and take a similar picture of the detail (step 826). The buyer sends his/her picture back to the P2PTG (step 828). The P2PTG responsively sends the photo from the buyer to the seller (step 830). The seller confirms that the picture is similar and locates the buyer at the location (step 832). The handshake may also be repeated in reverse, such that buyer is able to locate the seller in a similar manner to the foregoing (step 834). NM When the buyer and seller meet, the seller may then offer the goods for inspection by the buyer (step 836). The buyer then confirms that the item is acceptable (step 838). The seller then sends a virtual currency address from the seller's wallet to the Buyer via the P2PTG (step 840). Responsively, the P2PTG forwards the address to the buyer (step 842). The buyer then sends the agreed-upon denomination of virtual currency from the buyer's wallet address to the seller's address (step 844). Once the transaction is confirmed, for example, by auditing the P2PTG blockchain according to FIG. 7, the seller gives the goods to the buyer (step 846). The transaction then ends (step 848).

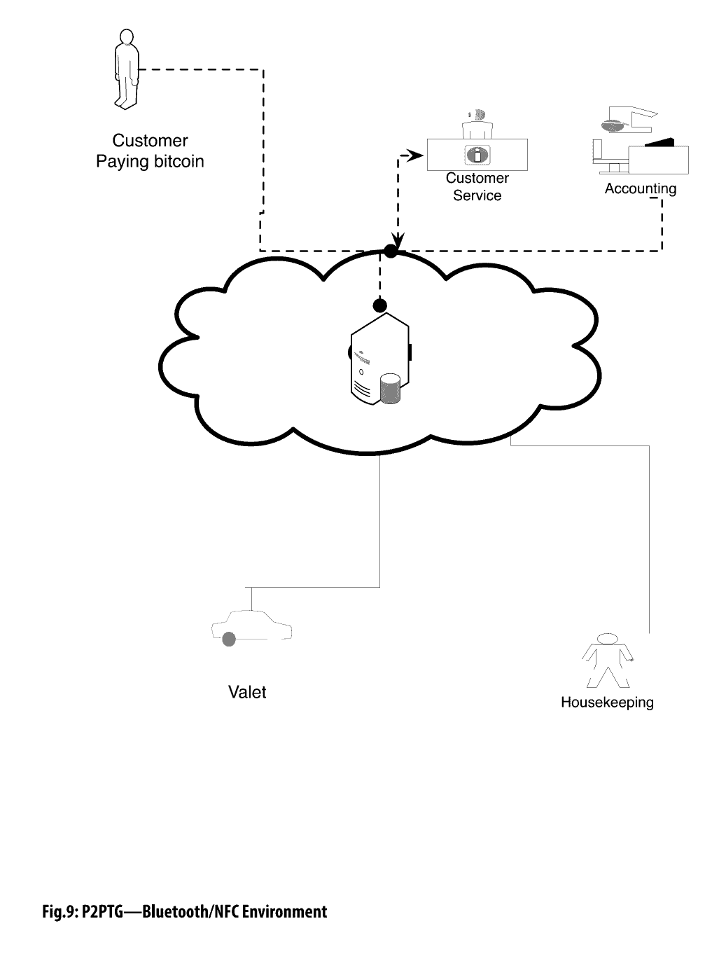

FIG. 9 shows a Bluetooth or NFC-enabled environment for enabling a P2PTG transaction, such as the transactions described in FIG. 8. Using Bluetooth or NFC beacons, various people and systems can be paid where real-world cash would normally be used, such as the valet, housekeeper at a hotel. In addition, by binding a smartphone or other portable electronic device to a hotel room upon entry, and then de-binding on exit, a hotel customer can keep very granular track of usage and payments with a seamless, friction-free payment and accounting system.

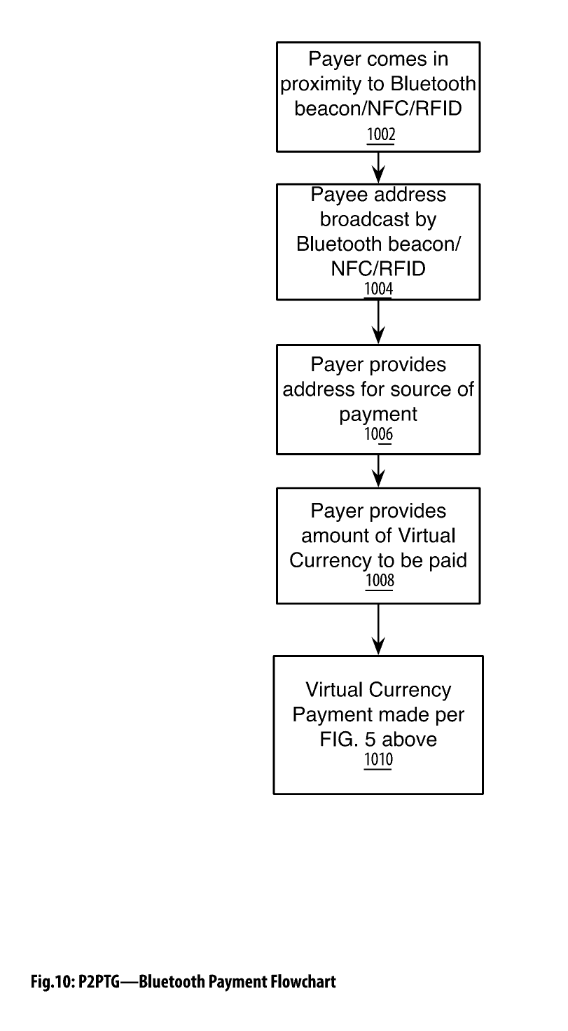

FIG. 10 shows a flowchart of a Bluetooth payment process for the P2PTG in an environment such as FIG. 9, where the location of the payee is fixed to a particular locale or property. At a commencement of the process, a payer comes in proximity to a bluetooth or NFC beacon established on the property (step 1002), where a payee's virtual currency address is broadcast by the beacon (step 1004). The payer provides a source address for a virtual currency payment (step 1006). The payer authorizes an amount of payment to be made in denominations of the virtual currency (step 1008). This virtual currency payment may then be completed in accordance with FIG. 5 above (step 1010).

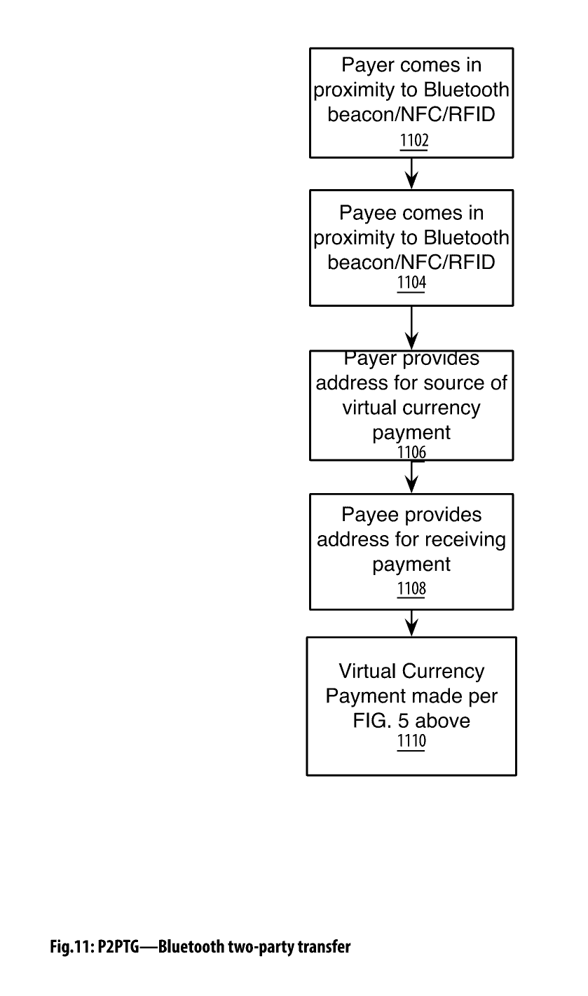

FIG. 11 shows a flowchart of a Bluetooth or NFC inter-party payment process enabled by the P2PTG. A payer comes in proximity to a third-party Bluetooth or NFC beacon (step 1102). A payee comes in proximity to the same beacon (step 1104). The payer provides his address as a source of virtual currency payment (step 1106). The payee provides a destination address corresponding to the seller's wallet for receiving payment of the virtual currency (step 1108). The virtual currency payment may then be made in accordance with FIG. 5 above (step 1110).

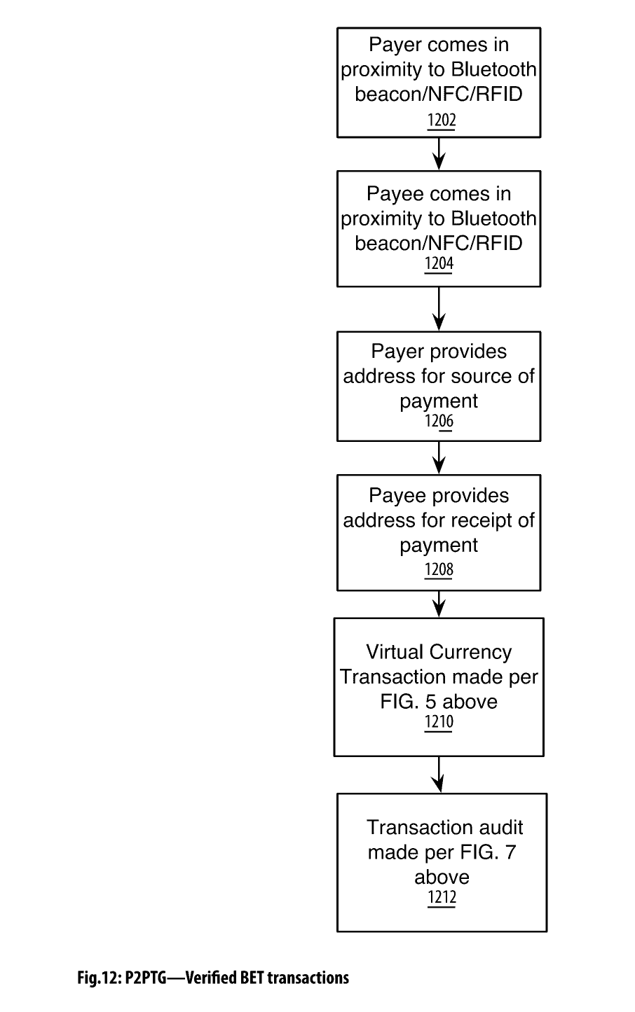

FIG. 12 shows a flowchart of a verified payment process for the P2PTG. A payer comes in proximity to a third-party Bluetooth or NFC beacon (step 1202). A payee comes in proximity to the same beacon (step 1204). The payer provides his address as a source of virtual currency payment (step 1206). The payee provides a destination address corresponding to the seller's wallet for receiving payment of the virtual currency (step 1208). The virtual currency payment may then be made in accordance with FIG. 5 above (step 1110). The transaction may then be verified according to the auditing process described in FIG. 7 above.

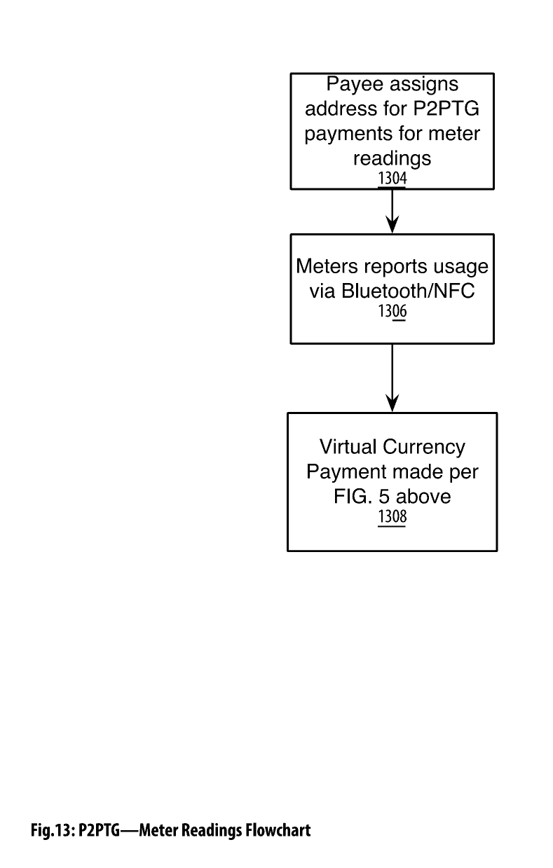

FIG. 13 shows a flowchart of a meter reading process enabled by the P2PTG. At a commencement of this process, a payee assigns a wallet address for P2PTG payments for meter readings (step 1304). For instance, the meters may represent gas, oil, water, electricity and/or other residential or commercial resource monitors that may be established and installed by utility companies, government agencies and the like. The meters reports usage via Bluetooth/NFC in communication or integrated with one or more of the meters. (step 1306). A virtual currency payment is then made periodically to cover resource usage in accordance with FIG. 5 above (step 1308).

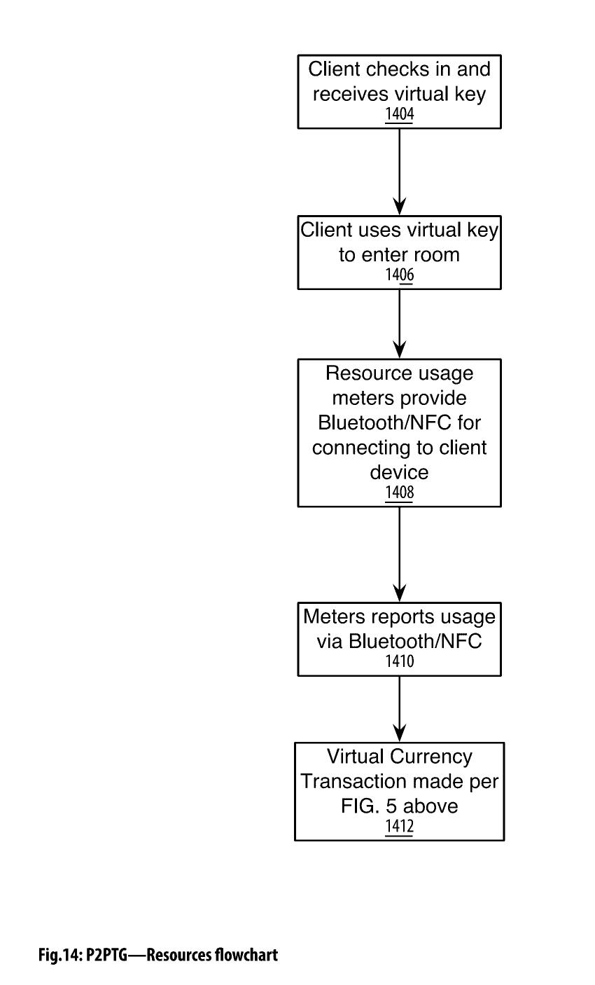

FIG. 14 shows a flowchart of a hotel resource monitoring process enabled by the P2PTG. At a commencement of this process, a hotel customer checks in and, after providing a wallet address for a source of virtual currency payment, receives on his smartphone or portable electronic device a virtual key that may be used in conjunction with Bluetooth or NFC beacons to gain access to the customer's hotel room (step 1404). Next, the customer uses virtual key to enter the room (Step 1406). Resource usage meters in the room provide a beacon for connecting to the customer's device (step 1408). The meters report resource usage via Bluetooth/NFC to both the customer's device and to the P2PTG (step 1410). Upon check out, a payment based on resource usage may then be made in accordance with FIG. 5 above (step 1412).

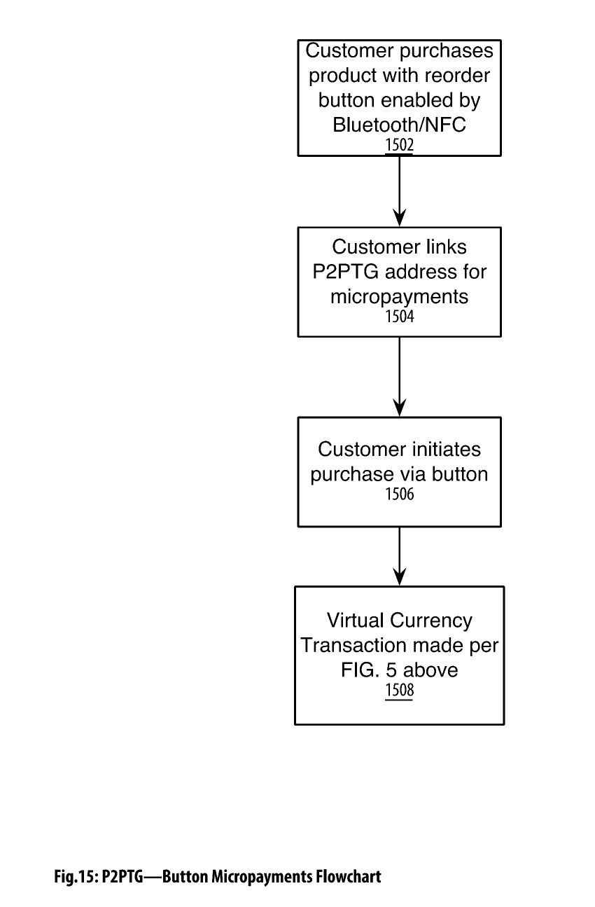

FIG. 15 shows a flowchart of a micropayment button payment process for the P2PTG. A customer may purchase a product having a re-order button enabled by Bluetooth/NFC (step 1502). One example of such functionality is provided by AMAZON DASH. As with the foregoing embodiments, such functionality may likewise be provided by Radio Frequency Identification (RFID) tags, NFC and other local code reading devices. The customer then links a P2PTG address for issuing micropayments in order to replenish the product on demand (step 1504). The customer initiates a purchase via the button (step 1506). A virtual currency payment may then be made in accordance with FIG. 5 above (step 1508).

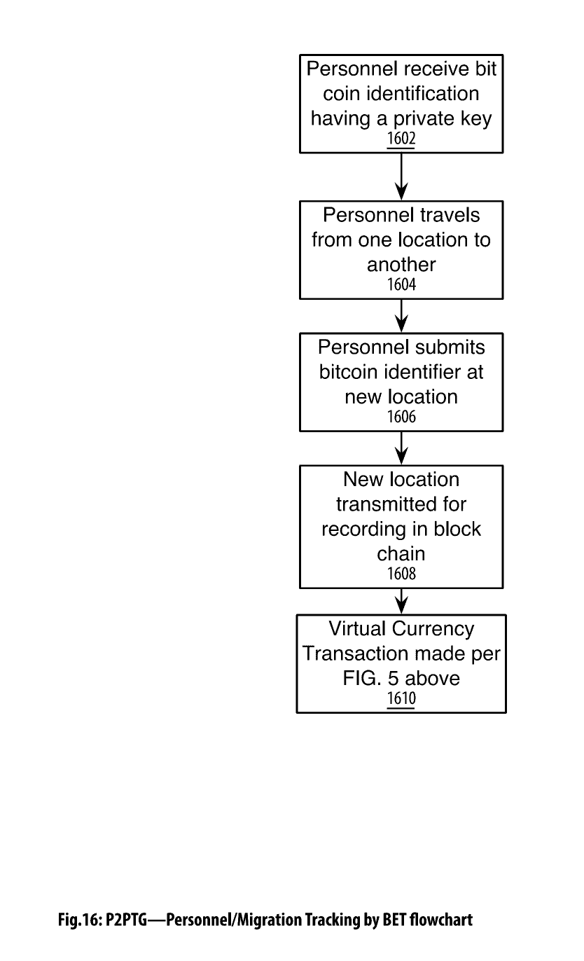

FIG. 16 shows a flowchart of a non-monetary personnel or item tracking process enabled by the P2PTG. At the start of such process, a person or item is assigned a virtual identifier in the form of a private key (step 1602). In various embodiments involving the tracking of personnel, biometric data of a person can be used as the identifier, or otherwise incorporated into the identifier. The biometric data may include retinal scan or fingerprint scan data, facial recognition technology and other known and useful biometric identifications. All or a meaningful portion of the biometric data may be used in the public key assigned to the person. Other similar implementations are readily contemplated.

Next, the person or item then travels from one location to another (step 1604). The person or item then submits the virtual identifies at a new geographic location (step 1606). The new location is transmitted to the P2PTG for recording in the block chain (step 1608). The process then ends 1610.

In non-monetary transactions, a virtual token can convey particularized information using OP Return codes or the like. Such field can place bits of information into the transaction's scriptSig value so that the irreversibility of the blockchain can be used to make that information verifiable at later times. OP_RETURN is a valid opcode to be used in a bitcoin transaction, which allows 80 arbitrary bytes to be used in an unspendable transaction.

An exemplary transaction which has an OP_RETURN in its scriptSig, the hash of which may be for example, a text string such as:

8bae12b5f4c088d940733dcd1455efc6a3a69cf9340e17a981286d3778615684

A command entered into a node of the P2PTG, such as:

$> bitcoind getrawtransaction
8bae12b5f4c088d940733dcd1455efc6a3a69cf9340e17a981286d3778615684

would yield the following output:

```
{
″hex″:
″0100000001c858ba5f607d762fe5be1dfe97ddc121827895c2562c4348d69d02b91dbb408e0100
00008b4830450220446df4e6b875af246800c8c976de7cd6d7d95016c4a8f7bcdbba81679cbda24
2022100c1ccfacfeb5e83087894aa8d9e37b11f5c054a75d030d5bfd94d17c5bc953d4a01410459
01f6367ea950a5665335065342b952c5d5d60607b3cdc6c69a03df1a6b915aa02eb5e07095a2548
a98dcdd84d875c6a3e130bafadfd45e694a3474e71405a4ffffffff020000000000000000156a13
636861726c6579206c6f766573206865696469400d0300000000001976a914b8268ce4d481413c4
e848ff353cd16104291c45b88ac00000000″,
″txid″ : ″8bae12b5f4c088d940733dcd1455efc6a3a69cf9340e17a981286d3778615684″,
″version″ : 1,
″locktime″ : 0,
″vin″ : [
  {
    ″txid″ :
″8e40bb1db9029dd648432c56c295788221c1dd97fe1dbee52f767d605fba58c8″,
    ″vout″ : 1,
    ″scriptSig″ : {
      ″asm″ :
″30450220446df4e6b875af246800c8c976de7cd6d7d95016c4a8f7bcdbba81679cbda242022100
c1ccfacfeb5e83087894aa8d9e37b11f5c054a75d030d5bfd94d17c5bc953d4a01
045901f6367ea950a5665335065342b952c5d5d60607b3cdc6c69a03df1a6b915aa02eb5e07095a
2548a98dcdd84d875c6a3e130bafadfd45e694a3474e71405a4″,
      ″hex″ :
″4830450220446df4e6b875af246800c8c976de7cd6d7d95016c4a8f7bcdbba81679cbda2420221
00c1ccfacfeb5e83087894aa8d9e37b11f5c054a75d030d5bfd94d17c5bc953d4a0141045901f63
67ea950a5665335065342b952c5d5d60607b3cdc6c69a03df1a6b915aa02eb5e07095a2548a98dc
dd84d875c6a3e130bafadfd45e694a3474e71405a4″
    },
    ″sequence″ : 4294967295
  }
],
″vout″ : [
  {
    ″value″ : 0.00000000,
    ″n″ : 0,
    ″scriptPubKey″ : {
      ″asm″ : ″OP_RETURN 636861726c6579206c6f766573206865696469″,
      ″hex″ : ″6a13636861726c6579206c6f766573206865696469″,
      ″type″ : ″nulldata″
    }
  },
  {
    ″value″ : 0.00200000,
    ″n″ : 1,
    ″scriptPubKey″ : {
      ″asm″ : ″OP_DUP OP_HASH160 b8268ce4d481413c4e848ff353cd16104291c45b
OP_EQUALVERIFY OP_CHECKSIG″,
      ″hex″ : ″76a914b8268ce4d481413c4e848ff353cd16104291c45b88ac″,
      ″reqSigs″ : 1,
      ″type″ : ″pubkeyhash″,
      ″addresses″ : [
        ″1HnhWpkMHMjgt167kvgcPyurMmsCQ2WPgg″
      ]
    }
  }
],
″blockhash″ :
″000000000000000004c31376d7619bf0f0d65af6fb028d3b4a410ea39d22554c″,
″confirmations″ : 2655,
″time″ : 1404107109,
″blocktime″ : 1404107109
```

The OP_RETURN code above is represented by the hex value 0x6a. This first byte is followed by a byte that represents the length of the rest of the bytes in the scriptPubKey. In this case, the hex value is 0x13, which means there are 19 more bytes. These bytes comprise the arbitrary less-than-80 bytes one may be allowed to send in a transaction marked by the OP_RETURN opcode.

For purposes of personnel tracking, the virtual currency distributed by the P2PTG system may include the following data fields in conjunction with OP Return Code mechanism:

| Unique Identifier (UN- | 10 positions (non-rewriteable) |
|---|---|
| ID) Code | |
| GPS start location | 20 positions (non-rewriteable) |
| GPS inter location | 20 positions (this field can keep changing) |
| GPS final location | 20 positions (cannot change) |
| Name | 14 positions |
| Gender | 1 position (M/F) |
| Age at assignment | 2 positions |
| Examples: | |
| UN-ID code | 0123456789 |
| GPS Start Location | 36.8166700, −1.2833300 |
| GPS inter location | 38.897709, −77.036543 |
| GPS final location | 41.283521, −70.099466 |
| Name | Doe, John |
| Gender | M |
| Age at assignment | 53 |

Each person is provided a unique identifier in addition to any government issued documentation associated with the person. The P2PTG blockchain database 1819j stores and maintains records from the person's departing country along with a photo, a recording, voiceprint, and/or other biometric identification of person along with the established identifier. At a later date, the P2PTG can access the Block Chain publicly, and personnel location can be transparent and tracked.

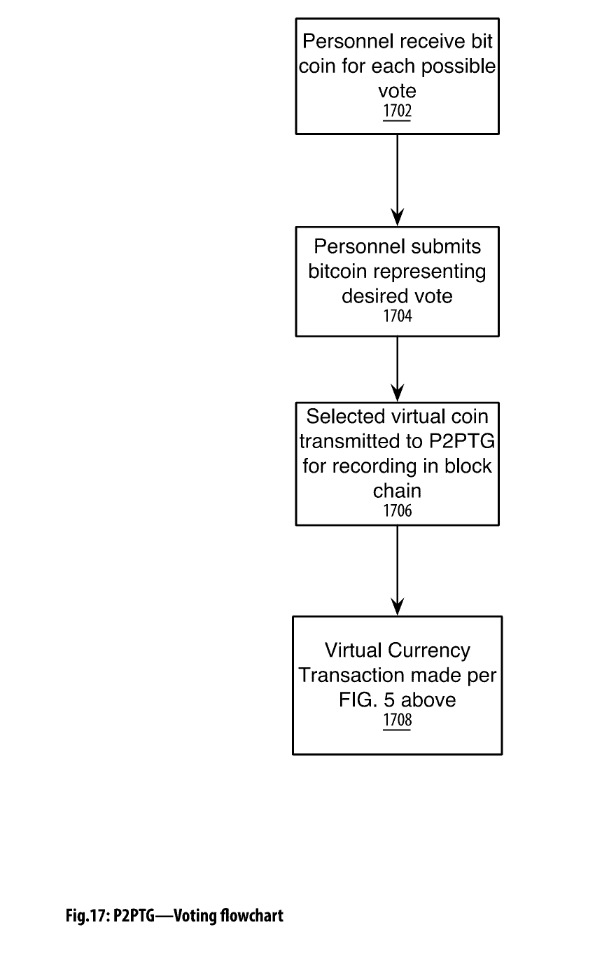

FIG. 17 shows a flowchart of a voting process for the P2PTG. At a commencement of this process, appropriate personnel may receive a virtual coin representing each possible vote (step 1702). Each virtual coin may contain a hash of the person's P2PTG identifier and the desired vote. The virtual coin would have no real or virtual currency associated with it. Each person submits a single virtual coin representing his or her desired vote (step 1704). The selected bit coin is transmitted to the P2PTG for recording in the block chain established for the vote (step 1706). This coin-enabled transaction may then be made in a similar manner as virtual currency transaction as described with respect to FIG. 5 above (step 1708). In various embodiments, the unused voting coins may be invalidated by the P2PTG upon the submission and validation of one of the virtual coins represented by the desired vote.

### Controller

FIG. 18 shows a block diagram illustrating embodiments of a controller. In this embodiment, the controller 1801 may serve to aggregate, process, store, search, serve, identify, instruct, generate, match, and/or facilitate interactions with a computer through Guided Target Transactions technologies, and/or other related data.

Typically, users, which may be people and/or other systems, may engage information technology systems (e.g., computers) to facilitate information processing. In turn, computers employ processors to process information; such processors 1803 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1829 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the P2PTG controller 1801 may be connected to and/or communicate with entities such as, but not limited to: one or more users from peripheral devices 1812 (e.g., user input devices 1811); an optional cryptographic processor device 1828; and/or a communications network 1813.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The P2PTG controller 1801 may be based on computer systems that may comprise, but are not limited to, components such as: a computer systemization 1802 connected to memory 1829.

### Computer Systemization

A computer systemization 1802 may comprise a clock 1830, central processing unit (“CPU(s)” and/or “processor(s)” (these terms are used interchangeable throughout the disclosure unless noted to the contrary)) 1803, a memory 1829 (e.g., a read only memory (ROM) 1806, a random access memory (RAM) 1805, etc.), and/or an interface bus 1807, and most frequently, although not necessarily, are all interconnected and/or communicating through a system bus 1804 on one or more (mother)board(s) 1802 having conductive and/or otherwise transportive circuit pathways through which instructions (e.g., binary encoded signals) may travel to effectuate communications, operations, storage, etc. The computer systemization may be connected to a power source 1886; e.g., optionally the power source may be internal. Optionally, a cryptographic processor 1826 may be connected to the system bus. In another embodiment, the cryptographic processor, transceivers (e.g., ICs) 1874, and/or sensor array (e.g., accelerometer, altimeter, ambient light, barometer, global positioning system (GPS) (thereby allowing P2PTG controller to determine its location), gyroscope, magnetometer, pedometer, proximity, ultra-violet sensor, etc.) 1873 may be connected as either internal and/or external peripheral devices 1812 via the interface bus I/O 1808 (not pictured) and/or directly via the interface bus 1807. In turn, the transceivers may be connected to antenna(s) 1875, thereby effectuating wireless transmission and reception of various communication and/or sensor protocols; for example the antenna(s) may connect to various transceiver chipsets (depending on deployment needs), including: Broadcom BCM4329FKUBG transceiver chip (e.g., providing 802.11n, Bluetooth 2.1+EDR, FM, etc.); a Broadcom BCM4752 GPS receiver with accelerometer, altimeter, GPS, gyroscope, magnetometer; a Broadcom BCM4335 transceiver chip (e.g., providing 2G, 3G, and 4G long-term evolution (LTE) cellular communications; 802.11ac, Bluetooth 4.0 low energy (LE) (e.g., beacon features)); a Broadcom BCM43341 transceiver chip (e.g., providing 2G, 3G and 4G LTE cellular communications; 802.11g/, Bluetooth 4.0, near field communication (NFC), FM radio); an Infineon Technologies X-Gold 618-PMB9800 transceiver chip (e.g., providing 2G/3G HSDPA/HSUPA communications); a MediaTek MT6620 transceiver chip (e.g., providing 802.11a/ac/b/g/n, Bluetooth 4.0 LE, FM, GPS; a Lapis Semiconductor ML8511 UV sensor; a maxim integrated MAX44000 ambient light and infrared proximity sensor; a Texas Instruments WiLink WL1283 transceiver chip (e.g., providing 802.11n, Bluetooth 3.0, FM, GPS); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU is often packaged in a number of formats varying from large supercomputer(s) and mainframe(s) computers, down to mini computers, servers, desktop computers, laptops, thin clients (e.g., Chromebooks), netbooks, tablets (e.g., Android, iPads, and Windows tablets, etc.), mobile smartphones (e.g., Android, iPhones, Nokia, Palm and Windows phones, etc.), wearable device(s) (e.g., watches, glasses, goggles (e.g., Google Glass), etc.), and/or the like. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1829 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; Apple's A series of processors (e.g., A5, A6, A7, A8, etc.); ARM's application, embedded and secure processors; IBM and/or Motorola's DragonBall and PowerPC; IBM's and Sony's Cell processor; Intel's 80X86 series (e.g., 80386, 80486), Pentium, Celeron, Core (2) Duo, i series (e.g., i3, i5, i7, etc.), Itanium, Xeon, and/or XScale; Motorola's 680X0 series (e.g., 68020, 68030, 68040, etc.); and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the P2PTG controller and beyond through various interfaces. Should processing requirements dictate a greater amount speed and/or capacity, distributed processors (e.g., see Distributed P2PTG below), mainframe, multi-core, parallel, and/or super-computer architectures may similarly be employed. Alternatively, should deployment requirements dictate greater portability, smaller mobile devices (e.g., Personal Digital Assistants (PDAs)) may be employed.

Depending on the particular implementation, features of the P2PTG may be achieved by implementing a microcontroller such as CAST's R8051XC2 microcontroller; Intel's MCS 51 (i.e., 8051 microcontroller); and/or the like. Also, to implement certain features of the P2PTG, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the P2PTG component collection (distributed or otherwise) and/or features may be implemented via the microprocessor and/or via embedded components; e.g., via ASIC, coprocessor, DSP, FPGA, and/or the like. Alternately, some implementations of the P2PTG may be implemented with embedded components that are configured and used to achieve a variety of features or signal processing.

Depending on the particular implementation, the embedded components may include software solutions, hardware solutions, and/or some combination of both hardware/software solutions. For example, P2PTG features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the P2PTG features. A hierarchy of programmable interconnects allow logic blocks to be interconnected as needed by the P2PTG system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the P2PTG may be developed on regular FPGAs and then migrated into a fixed version that more resembles ASIC implementations. Alternate or coordinating implementations may migrate P2PTG controller features to a final ASIC instead of or in addition to FPGAs. Depending on the implementation all of the aforementioned embedded components and microprocessors may be considered the “CPU” and/or “processor” for the P2PTG.

### Power Source

The power source 1886 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1886 is connected to at least one of the interconnected subsequent components of the P2PTG thereby providing an electric current to all subsequent components. In one example, the power source 1886 is connected to the system bus component 1804. In an alternative embodiment, an outside power source 1886 is provided through a connection across the I/O 1808 interface. For example, a USB and/or IEEE 1394 connection carries both data and power across the connection and is therefore a suitable source of power.

### Interface Adapters

Interface bus(ses) 1807 may accept, connect, and/or communicate to a number of interface adapters, conventionally although not necessarily in the form of adapter cards, such as but not limited to: input output interfaces (I/O) 1808, storage interfaces 1809, network interfaces 1810, and/or the like. Optionally, cryptographic processor interfaces 1827 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1809 may accept, communicate, and/or connect to a number of storage devices such as, but not limited to: storage devices 1814, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1810 may accept, communicate, and/or connect to a communications network 1813. Through a communications network 1813, the P2PTG controller is accessible through remote clients 1833b (e.g., computers with web browsers) by users 1833a. Network interfaces may employ connection protocols such as, but not limited to: direct connect, Ethernet (thick, thin, twisted pair 10/100/1000/10000 Base T, and/or the like), Token Ring, wireless connection such as IEEE 802.11a-x, and/or the like. Should processing requirements dictate a greater amount speed and/or capacity, distributed network controllers (e.g., see Distributed P2PTG below), architectures may similarly be employed to pool, load balance, and/or otherwise decrease/increase the communicative bandwidth required by the P2PTG controller. A communications network may be any one and/or the combination of the following: a direct interconnection; the Internet; Interplanetary Internet (e.g., Coherent File Distribution Protocol (CFDP), Space Communications Protocol Specifications (SCPS), etc.); a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a cellular, WiFi, Wireless Application Protocol (WAP), I-mode, and/or the like); and/or the like. A network interface may be regarded as a specialized form of an input output interface. Further, multiple network interfaces 1810 may be used to engage with various communications network types 1813. For example, multiple network interfaces may be employed to allow for the communication over broadcast, multicast, and/or unicast networks.

Input Output interfaces (I/O) 1808 may accept, communicate, and/or connect to user, peripheral devices 1812 (e.g., input devices 1811), cryptographic processor devices 1828, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; touch interfaces: capacitive, optical, resistive, etc. displays; video interface: Apple Desktop Connector (ADC), BNC, coaxial, component, composite, digital, Digital Visual Interface (DVI), (mini) displayport, high-definition multimedia interface (HDMI), RCA, RF antennae, S-Video, VGA, and/or the like; wireless transceivers: 802.11a/ac/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

Peripheral devices 1812 may be connected and/or communicate to I/O and/or other facilities of the like such as network interfaces, storage interfaces, directly to the interface bus, system bus, the CPU, and/or the like. Peripheral devices may be external, internal and/or part of the P2PTG controller. Peripheral devices may include: antenna, audio devices (e.g., line-in, line-out, microphone input, speakers, etc.), cameras (e.g., gesture (e.g., Microsoft Kinect) detection, motion detection, still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), infrared (IR) transceiver, network interfaces, printers, scanners, sensors/sensor arrays and peripheral extensions (e.g., ambient light, GPS, gyroscopes, proximity, temperature, etc.), storage devices, transceivers (e.g., cellular, GPS, etc.), video devices (e.g., goggles, monitors, etc.), video sources, visors, and/or the like. Peripheral devices often include types of input devices (e.g., cameras).

User input devices 1811 often are a type of peripheral device 512 (see above) and may include: card readers, dongles, finger print readers, gloves, graphics tablets, joysticks, keyboards, microphones, mouse (mice), remote controls, security/biometric devices (e.g., fingerprint reader, iris reader, retina reader, etc.), touch screens (e.g., capacitive, resistive, etc.), trackballs, trackpads, styluses, and/or the like.

It should be noted that although user input devices and peripheral devices may be employed, the P2PTG controller may be embodied as an embedded, dedicated, and/or monitor-less (i.e., headless) device, wherein access would be provided over a network interface connection.

Cryptographic units such as, but not limited to, microcontrollers, processors 1826, interfaces 1827, and/or devices 1828 may be attached, and/or communicate with the P2PTG controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1829. However, memory is a fungible technology and resource, thus, any number of memory embodiments may be employed in lieu of or in concert with one another. It is to be understood that the P2PTG controller and/or a computer systemization may employ various forms of memory 1829. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 1829 will include ROM 1806, RAM 1805, and a storage device 1814. A storage device 1814 may be any conventional computer system storage. Storage devices may include: an array of devices (e.g., Redundant Array of Independent Disks (RAID)); a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); RAM drives; solid state memory devices (USB memory, solid state drives (SSD), etc.); other processor-readable storage mediums; and/or other devices of the like. Thus, a computer systemization generally requires and makes use of memory.

### Component Collection

The memory 1829 may contain a collection of program and/or database components and/or data such as, but not limited to: operating system component(s) 1815 (operating system); information server component(s) 1816 (information server); user interface component(s) 1817 (user interface); Web browser component(s) 1818 (Web browser); database(s) 1819; mail server component(s) 1821; mail client component(s) 1822; cryptographic server component(s) 1820 (cryptographic server); the P2PTG component(s) 1835; and/or the like (i.e., collectively a component collection). These components may be stored and accessed from the storage devices and/or from storage devices accessible through an interface bus. Although non-conventional program components such as those in the component collection, typically, are stored in a local storage device 1814, they may also be loaded and/or stored in memory such as: peripheral devices, RAM, remote storage facilities through a communications network, ROM, various forms of memory, and/or the like.

### Operating System

The operating system component 1815 is an executable program component facilitating the operation of the P2PTG controller. Typically, the operating system facilitates access of I/O, network interfaces, peripheral devices, storage devices, and/or the like. The operating system may be a highly fault tolerant, scalable, and secure system such as: Apple's Macintosh OS X (Server); AT&T Plan 9; Be OS; Google's Chrome; Microsoft's Windows 7/8; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/Mobile/NT/Vista/XP (Server), Palm OS, and/or the like. Additionally, for robust mobile deployment applications, mobile operating systems may be used, such as: Apple's iOS; China Operating System COS; Google's Android; Microsoft Windows RT/Phone; Palm's WebOS; Samsung/Intel's Tizen; and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the P2PTG controller to communicate with other entities through a communications network 1813. Various communication protocols may be used by the P2PTG controller as a subcarrier transport mechanism for interaction, such as, but not limited to: multicast, TCP/IP, UDP, unicast, and/or the like.

### Information Server

An information server component 1816 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective−) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the P2PTG controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the P2PTG database 1819, operating systems, other program components, user interfaces, Web browsers, and/or the like.

Access to the P2PTG database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the P2PTG. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the P2PTG as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple's iOS, Macintosh Operating System's Aqua; IBM's OS/2; Google's Chrome (e.g., and other webbrowser/cloud based client OSs); Microsoft's Windows varied UIs 2000/2003/3.1/95/98/CE/Millenium/Mobile/NT/Vista/XP (Server) (i.e., Aero, Surface, etc.); Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1817 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1818 is a stored program component that is executed by a CPU. The Web browser may be a conventional hypertext viewing application such as Apple's (mobile) Safari, Google's Chrome, Microsoft Internet Explorer, Mozilla's Firefox, Netscape Navigator, and/or the like. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the P2PTG enabled nodes. The combined application may be nugatory on systems employing standard Web browsers.

### Mail Server

A mail server component 1821 is a stored program component that is executed by a CPU 1803. The mail server may be a conventional Internet mail server such as, but not limited to: dovecot, Courier IMAP, Cyrus IMAP, Maildir, Microsoft Exchange, sendmail, and/or the like. The mail server may allow for the execution of program components through facilities such as ASP, ActiveX, (ANSI) (Objective−) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the P2PTG. Alternatively, the mail server component may be distributed out to mail service providing entities such as Google's cloud services (e.g., Gmail and notifications may alternatively be provided via messenger services such as AOL's Instant Messenger, Apple's iMessage, Google Messenger, SnapChat, etc.).

Access to the P2PTG mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1822 is a stored program component that is executed by a CPU 1803. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1820 is a stored program component that is executed by a CPU 1803, cryptographic processor 1826, cryptographic processor interface 1827, cryptographic processor device 1828, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), Transport Layer Security (TLS), and/or the like. Employing such encryption security protocols, the P2PTG may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the P2PTG component to engage in secure transactions if so desired. The cryptographic component facilitates the secure accessing of resources on the P2PTG and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The P2PTG Database

The P2PTG database component 1819 may be embodied in a database and its stored data. The database is a stored program component, which is executed by the CPU; the stored program component portion configuring the CPU to process the stored data. The database may be a conventional, fault tolerant, relational, scalable, secure database such as MySQL, Oracle, Sybase, etc. may be used. Additionally, optimized fast memory and distributed databases such as IBM's Netezza, MongoDB's MongoDB, opensource Hadoop, opensource VoltDB, SAP's Hana, etc. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. Alternative key fields may be used from any of the fields having unique value sets, and in some alternatives, even non-unique values in combinations with other fields. More precisely, they uniquely identify rows of a table on the “one” side of a one-to-many relationship.

Alternatively, the P2PTG database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the P2PTG database is implemented as a data-structure, the use of the P2PTG database 1819 may be integrated into another component such as the P2PTG component 1835. Also, the database may be implemented as a mix of data structures, objects, and relational structures. Databases may be consolidated and/or distributed in countless variations (e.g., see Distributed P2PTG below). Portions of databases, e.g., tables, may be exported and/or imported and thus decentralized and/or integrated.

In one embodiment, the database component 1819 includes several tables 1819a-h:

An accounts table 1819a includes fields such as, but not limited to: an accountID, accountOwnerID, accountContactID, assetIDs, deviceIDs, paymentIDs, transactionIDs, userIDs, accountType (e.g., agent, entity (e.g., corporate, non-profit, partnership, etc.), individual, etc.), accountCreationDate, accountUpdateDate, accountName, accountNumber, routingNumber, linkWalletsID, accountPrioritAccaountRatio, accountAddress, accountState, accountZIPcode, accountCountry, accountEmail, accountPhone, accountAuthKey, accountlPaddress, accountURLAccessCode, accountPortNo, accountAuthorizationCode, accountAccessPrivileges, accountPreferences, accountRestrictions, and/or the like;

A users table 1819b includes fields such as, but not limited to: a userID, userSSN, taxID, userContactID, accountID, assetIDs, deviceIDs, paymentIDs, transactionIDs, userType (e.g., agent, entity (e.g., corporate, non-profit, partnership, etc.), individual, etc.), namePrefix, firstName, middleName, lastName, nameSuffix, DateOfBirth, userAge, userName, userEmail, userSocialAccountID, contactType, contactRelationship, userPhone, userAddress, userCity, userState, userZIPCode, userCountry, userAuthorizationCode, userAccessPrivilges, userPreferences, userRestrictions, and/or the like (the user table may support and/or track multiple entity accounts on a P2PTG);

An devices table 1819c includes fields such as, but not limited to: deviceID, sensorIDs, accountID, assetIDs, paymentIDs, deviceType, deviceName, deviceManufacturer, deviceModel, deviceVersion, deviceSerialNo, devicelPaddress, deviceMACaddress, device_ECID, deviceUUID, deviceLocation, deviceCertificate, deviceOS, appIDs, deviceResources, deviceSession, authKey, deviceSecureKey, walletAppinstalledFlag, deviceAccessPrivileges, devicePreferences, deviceRestrictions, hardware_config, software_config, storagelocation, sensor_value, pin_reading, data_length, channel_requirement, sensor_name, sensor_model_no, sensor_manufacturer, sensor_type, sensor_serial_number, sensor_power_requirement, device_power_requirement, location, sensor_associated_tool, sensor_dimensions, device_dimensions, sensor_communications_type, device_communications_type, power_percentage, power_condition, temperature_setting, speed_adjust, hold_duration, part_actuation, and/or the like. Device table may, in some embodiments, include fields corresponding to one or more Bluetooth profiles, such as those published at https://www.bluetooth.org/en-us/specification/adopted-specifications, and/or other device specifications, and/or the like;

An apps table 1819d includes fields such as, but not limited to: appID, appName, appType, appDependencies, accountID, deviceIDs, transactionID, userID, appStoreAuthKey, appStoreAccountID, appStorelPaddress, appStoreURLaccessCode, appStorePortNo, appAccessPrivileges, appPreferences, appRestrictions, portNum, access_API_call, linked_wallets_list, and/or the like;

An assets table 1819e includes fields such as, but not limited to: assetID, accountID, userID, distributorAccountID, distributorPaymentID, distributorOnwerID, assetOwnerID, assetType, assetSourceDeviceID, assetSourceDeviceType, assetSourceDeviceName, assetSourceDistributionChannelID, assetSourceDistributionChannelType, assetSourceDistributionChannelName, assetTargetChannelID, assetTargetChannelType, assetTargetChannelName, assetName, assetSeriesName, assetSeriesSeason, assetSeriesEpisode, assetCode, assetQuantity, assetCost, assetPrice, assetValue, assetManufactuer, assetModelNo, assetSerialNo, assetLocation, assetAddress, assetState, assetZIPcode, assetState, assetCountry, assetEmail, assetIPaddress, assetURLaccessCode, assetOwnerAccountID, subscriptionIDs, assetAuthroizationCode, assetAccessPrivileges, assetPreferences, assetRestrictions, assetAPI, assetAPIconnectionAddress, and/or the like;

A payments table 1819f includes fields such as, but not limited to: paymentID, accountID, userID, paymentType, paymentAccountNo, paymentAccountName, paymentAccountAuthorizationCodes, paymentExpirationDate, paymentCCV, paymentRoutingNo, paymentRoutingType, paymentAddress, paymentState, paymentZIPcode, paymentCountry, paymentEmail, paymentAuthKey, paymentlPaddress, paymentURLaccessCode, paymentPortNo, paymentAccessPrivileges, paymentPreferences, payementRestrictions, and/or the like;

An transactions table 1819g includes fields such as, but not limited to: transactionID, accountID, assetIDs, deviceIDs, paymentIDs, transactionIDs, userID, merchantID, transactionType, transactionDate, transactionTime, transactionAmount, transactionQuantity, transactionDetails, productsList, productType, productTitle, productsSummary, productParamsList, transactionNo, transactionAccessPrivileges, transactionPreferences, transactionRestrictions, merchantAuthKey, merchantAuthCode, and/or the like;

An merchants table 1819h includes fields such as, but not limited to: merchantID, merchantTaxID, merchanteName, merchantContactUserID, accountID, issuerID, acquirerID, merchantEmail, merchantAddress, merchantState, merchantZIPcode, merchantCountry, merchantAuthKey, merchantIPaddress, portNum, merchantURLaccessCode, merchantPortNo, merchantAccessPrivileges, merchantPreferences, merchantRestrictions, and/or the like;

An ads table 1819i includes fields such as, but not limited to: adID, advertiserID, adMerchantID, adNetworkTD, adName, adTags, advertiserName, adSponsor, adTime, adGeo, adAttributes, adFormat, adProduct, adText, adMedia, adMediaID, adChannelID, adTagTime, adAudioSignature, adHash, adTemplateID, adTemplateData, adSourceID, adSourceName, adSourceServerlP, adSourceURL, adSourceSecurityProtocol, adSourceFTP, adAuthKey, adAccessPrivileges, adPreferences, adRestrictions, adNetworkXchangeID, adNetworkXchangeName, adNetworkXchangeCost, adNetworkXchangeMetricType (e.g., CPA, CPC, CPM, CTR, etc.), adNetworkXchangeMetricValue, adNetworkXchangeServer, adNetworkXchangePortNumber, publisherID, publisherAddress, publisherURL, publisherTag, publisherindustry, publisherName, publisherDescription, siteDomain, siteURL, siteContent, siteTag, siteContext, sitelmpression, siteVisits, siteHeadline, sitePage, siteAdPrice, sitePlacement, sitePosition, bidID, bidExchange, bidOS, bidTarget, bidTimestamp, bidPrice, bidlmpressionID, bidType, bidScore, adType (e.g., mobile, desktop, wearable, largescreen, interstitial, etc.), assetID, merchantID, deviceID, userID, accountID, impressionID, impressionOS, impressionTimeStamp, impressionGeo, impressionAction, impressionType, impressionPublisherID, impressionPublisherURL, and/or the like.

A blockchain table 1819j includes fields such as, but not limited to: block(1) . . . block(n). The blockchain table 1819j may be used to store blocks that form blockchains of transactions as described herein.

A public key table 1819k includes fields such as, but not limited to: accountID, accountOwnerID, accountContactID, public_key. The public key table 1819k may be used to store and retrieve the public keys generated for clients of the P2PTG system as described herein.

A private key table 1819l includes fields such as, but not limited to: ownerID, OwnertContact, private_key. The private keys held here will not be the private keys of register users of the P2PTG system, but instead will be used to authentic transactions originating from the P2PTG system.

An OpReturn table 1819m includes fields such as, but not limited to: transactionID, OpReturn_Value1 . . . OpReturn_Value80; where eachOpReturn Value entry stores one byte in the OpReturn field for the purposes described above.

A wallet table 1819n includes fields such as, but not limited to: an accountID, accountOwnerID, accountContactID, transactionID s, SourceAddress(1) . . . . SourceAddress(n), BalanceAddress(1) . . . Balance address(n). The wallet table 1819n may be used to store wallet information as described in the foregoing.

In one embodiment, the P2PTG database 1819 may interact with other database systems. For example, employing a distributed database system, queries and data access by search P2PTG component may treat the combination of the P2PTG database, an integrated data security layer database as a single database entity (e.g., see Distributed P2PTG below).

In one embodiment, user programs may contain various user interface primitives, which may serve to update the P2PTG. Also, various accounts may require custom database tables depending upon the environments and the types of clients the P2PTG may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1819a-h______. The P2PTG may be configured to keep track of various settings, inputs, and parameters via database controllers.

The P2PTG database may communicate to and/or with other components in a component collection, including itself, and/or facilities of the like. Most frequently, the P2PTG database communicates with the P2PTG component, other program components, and/or the like. The database may contain, retain, and provide information regarding other nodes and data.

### The P2PTGs

The component 1835 is a stored program component that is executed by a CPU. In one embodiment, the P2PTG component incorporates any and/or all combinations of the aspects of the P2PTG that was discussed in the previous figures. As such, the P2PTG affects accessing, obtaining and the provision of information, services, transactions, and/or the like across various communications networks. The features and embodiments of the P2PTG discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the P2PTG's features and facilities, and in many cases reduce the costs, energy consumption/requirements, and extend the life of P2PTG's underlying infrastructure; this has the added benefit of making the P2PTG more reliable. Similarly, many of the features and mechanisms are designed to be easier for users to use and access, thereby broadening the audience that may enjoy/employ and exploit the feature sets of the P2PTG; such ease of use also helps to increase the reliability of the P2PTG. In addition, the feature sets include heightened security as noted via the Cryptographic components 1820, 1826, 1828 and throughout, making access to the features and data more reliable and secure

The P2PTG transforms virtual wallet address inputs, via P2PTG components (e.g., Virtual Currency Component, Blockchain Component, Transaction Confirmation Component), into transaction confirmation outputs.

The P2PTG component enabling access of information between nodes may be developed by employing standard development tools and languages such as, but not limited to: Apache components, Assembly, ActiveX, binary executables, (ANSI) (Objective−) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the P2PTG server employs a cryptographic server to encrypt and decrypt communications. The P2PTG component may communicate to and/or with other components in a component collection, including itself, and/or facilities of the like. Most frequently, the P2PTG component communicates with the P2PTG database, operating systems, other program components, and/or the like. The P2PTG may contain, communicate, generate, obtain, and/or provide program component, system, user, and/or data communications, requests, and/or responses.

A Login Component 1841 is a stored program component that is executed by a CPU. In various embodiments, the Login Component 1841 incorporates any and/or all combinations of the aspects of logging into the P2PTG that was discussed above with respect to FIG. 4.

A Virtual Currency Transaction Component 1842 is a stored program component that is executed by a CPU. In various embodiments, the Virtual Currency Transaction Component 1842 incorporates any and/or all combinations of the aspects of the P2PTG that was discussed above with respect to FIG. 5.

A Blockchain Component 1843 is a stored program component that is executed by a CPU. In one embodiment, the Blockchain Component 1843 incorporates any and/or all combinations of the aspects of the P2PTG that was discussed in the previous figures.

A Transaction Confirmation Component 1844 is a stored program component that is executed by a CPU. In one embodiment, the Transaction Confirmation Component 1844 incorporates any and/or all combinations of the aspects of the P2PTG that was discussed above with respect to FIGS. 5 and 7.

### Distributed P2PTGs

The structure and/or operation of any of the P2PTG node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion. As such a combination of hardware may be distributed within a location, within a region and/or globally where logical access to a controller may be abstracted as a singular node, yet where a multitude of private, semiprivate and publically accessible node controllers (e.g., via dispersed data centers) are coordinated to serve requests (e.g., providing private cloud, semi-private cloud, and public cloud computing resources) and allowing for the serving of such requests in discrete regions (e.g., isolated, local, regional, national, global cloud access).

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the P2PTG controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like. For example, cloud services such as Amazon Data Services, Microsoft Azure, Hewlett Packard Helion, IBM Cloud services allow for P2PTG controller and/or P2PTG component collections to be hosted in full or partially for varying degrees of scale.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the P2PTG controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(′Content-Type: text/plain′);
// set ip address and port to listen to for incoming data
$address = ′192.168.0.100′;
$port = 255;
// create a server-side SSL socket, listen for/accept incoming
communication
$sock = socket_create(AF_INET, SOCK_STREAM, 0);
socket_bind($sock, $address, $port) or die(′Could not bind to address′);
socket_listen($sock);
$client = socket_accept($sock);
// read input data from client device in 1024 byte blocks until end of
message
do {
  $input = ′′′′;
  $input = socket_read($client, 1024);
  $data .= $input;
} while($input != ″″);
// parse data to extract variables
$obj = json_decode($data, true);
// store input data in a database
mysql_connect(″201.408.185.132″,$D6server,$password);
// access database server
mysql_select(″CLIENT_DB.SQL″); // select database to append
mysql_query(″INSERT INTO UserTable (transmission)
VALUES ($data)″); // add data to UserTable table in a CLIENT database
mysql_close(″CLIENT_DB.SQL″); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.
jsp?topic=/com.ibm.IBMDI.doc/referenceguide295.htm

and other parser implementations:

http://publib.boulder.ibm.com/infocenter/tivihelp/v2r1/index.
jsp?topic=/com.ibm.IBMDI.doc/referenceguide259.htm

all of which are hereby expressly incorporated by reference.

Additional P2PTG embodiments include:
1. A migration displacement tracking apparatus, comprising:
a memory;
a component collection in any of memory and communication, including:
   a migration component;
a processor disposed in communication with the memory, and configured to issue a plurality of processing instructions from the component collection stored in the memory,
   wherein a processor issues instructions from the migration component, stored in the memory, to:
      obtain a unique wallet identifier from a migrant wallet source associated with a user;
      obtain a geographic transaction request from the migrant wallet source;
      commit the geographic transaction request to a distributed block chain database configured to propagate the geographic transaction request across a distributed block chain database network;
      provide a starting displacement region at an initial time;
      provide a target displacement region at a subsequent time;
      query the distributed block chain database for users matching a starting displacement region at the initial time;
      select a subset of lost or displaced users at the target displacement region at the subsequent time from the results of the query;
      identify lost users from the query that were not in the selected subset.
2. The apparatus of embodiment 1, wherein the transaction request includes a number of additional fields specified in an 80 byte transaction payload.
3. The apparatus of embodiment 2, wherein the fields include longitude and latitude.
4. The apparatus of embodiment 2, wherein the additional fields include attributes.
5. The apparatus of embodiment 4, wherein the additional fields include size.
6. The apparatus of embodiment 4, wherein attributes include nationality.
7. The apparatus of embodiment 4, wherein attributes include the user's identification information.
8. A processor-readable migration displacement tracking non-transient medium storing processor-executable components, the components comprising:
a component collection stored in the medium, including:
   a migration component;
   wherein the component collection, stored in the medium, includes processor-issuable instructions to:
      obtain a unique wallet identifier from a migrant wallet source associated with a user;
      obtain a geographic transaction request from the migrant wallet source;
      commit the geographic transaction request to a distributed block chain database configured to propagate the geographic transaction request across a distributed block chain database network;
      provide a starting displacement region at an initial time;
      provide a target displacement region at a subsequent time;
      query the distributed block chain database for users matching a starting displacement region at the initial time;
      select a subset of lost or displaced users at the target displacement region at the subsequent time from the results of the query;
      identify lost users from the query that were not in the selected subset.
9. The processor-readable migration displacement tracking non-transient medium of embodiment 8, wherein the transaction request includes a number of additional fields specified in an 80 byte transaction payload.
10. The processor-readable migration displacement tracking non-transient medium of embodiment 9, wherein the fields include longitude and latitude.
11. The processor-readable migration displacement tracking non-transient medium of embodiment 9, wherein the additional fields include attributes.
12. The processor-readable migration displacement tracking non-transient medium of embodiment 11, wherein the additional fields include size.
13. The processor-readable migration displacement tracking non-transient medium of embodiment 11, wherein attributes include nationality.
14. The processor-readable migration displacement tracking non-transient medium of embodiment 11, wherein attributes include the user's identification information.
15. A processor-implemented migration displacement tracking method, comprising: executing processor-implemented migration component instructions to:
   obtain a unique wallet identifier from a migrant wallet source associated with a user;
   obtain a geographic transaction request from the migrant wallet source;
   commit the geographic transaction request to a distributed block chain database configured to propagate the geographic transaction request across a distributed block chain database network;
   provide a starting displacement region at an initial time;
   provide a target displacement region at a subsequent time;
   query the distributed block chain database for users matching a starting displacement region at the initial time;
   select a subset of lost or displaced users at the target displacement region at the subsequent time from the results of the query;
   identify lost users from the query that were not in the selected subset.
16. The processor-implemented migration displacement tracking method of embodiment 15, wherein the transaction request includes a number of additional fields specified in an 80 byte transaction payload.
17. The processor-implemented migration displacement tracking method of embodiment 16, wherein the fields include longitude and latitude.
18. The processor-implemented migration displacement tracking method of embodiment 16, wherein the additional fields include attributes.
19. The processor-implemented migration displacement tracking method of embodiment 16, wherein the additional fields include size.
20. The processor-implemented migration displacement tracking method of embodiment 16, wherein attributes include nationality.
21. The processor-implemented migration displacement tracking method of embodiment 16, wherein attributes include the user's identification information.
22. A processor-implemented migration displacement tracking system, comprising:
a migration component means, to:
   obtain a unique wallet identifier from a migrant wallet source associated with a user;
   obtain a geographic transaction request from the migrant wallet source;
   commit the geographic transaction request to a distributed block chain database configured to propagate the geographic transaction request across a distributed block chain database network;
   provide a starting displacement region at an initial time;
   provide a target displacement region at a subsequent time;
   query the distributed block chain database for users matching a starting displacement region at the initial time;
   select a subset of lost or displaced users at the target displacement region at the subsequent time from the results of the query;
   identify lost users from the query that were not in the selected subset.
23. The processor-implemented migration displacement tracking system of embodiment 22, wherein the transaction request includes a number of additional fields specified in an 80 byte transaction payload.
24. The processor-implemented migration displacement tracking system of embodiment 22, wherein the fields include longitude and latitude.
25. The processor-implemented migration displacement tracking system of embodiment 22, wherein the additional fields include attributes.
26. The processor-implemented migration displacement tracking system of embodiment 22, wherein the additional fields include size.
27. The processor-implemented migration displacement tracking system of embodiment 22, wherein attributes include nationality.
28. The processor-implemented migration displacement tracking system of embodiment 22, wherein attributes include the user's identification information.
29. A point-to-point payment guidance apparatus, comprising:
a memory;
a component collection in any of memory and communication, including:
   a point-to-point guidance component;
a processor disposed in communication with the memory, and configured to issue a plurality of processing instructions from the component collection stored in the memory,
   wherein a processor issues instructions from the point-to-point guidance component, stored in the memory, to:
      obtain a target wallet identifier registration at a beacon;
      register the target wallet identifier with the beacon;
      obtain a unique wallet identifier from a migrant wallet source associated with a user at the beacon;
      obtain a target transaction request at the beacon from the migrant wallet source;
      commit the target transaction request for the amount specified in the target transaction request to a distributed block chain database configured to propagate the target transaction request across a distributed block chain database network for payment targeted to the target wallet identifier registered at the beacon.
30. The apparatus of embodiment 29, wherein the beacon is registered to an organization.
31. The apparatus of embodiment 30, wherein the target wallet identifier is of an employee of the organization.
32. The apparatus of embodiment 31, further, comprising:
   verify the target wallet identifier is associated with the organization.
33. The apparatus of embodiment 32, wherein the verification includes identifying the target wallet identifier exists in the organization's database.
34. The apparatus of embodiment 32, wherein the verification includes authentication credentials.
35. The apparatus of embodiment 34, wherein the authentication credentials are digitally signed.
36. The apparatus of embodiment 34, wherein the authentication credentials are encrypted.
37. The apparatus of embodiment 34, wherein the registration of the target wallet occurs upon the verification.
38. The apparatus of embodiment 29, wherein the target transaction request includes a number of additional fields specified in an 80 byte transaction payload.
39. The apparatus of embodiment 38, wherein the fields include a tip amount.
40. The apparatus of embodiment 38, wherein the fields include the beacon's unique identifier.
41. The apparatus of embodiment 38, wherein the fields include the target wallet identifier.
42. The apparatus of embodiment 38, wherein the fields include the user's identification information.
43. The apparatus of embodiment 29, wherein the beacon is a target mobile user device with access to a target user's target wallet associated with the target wallet identifier.
44. The apparatus of embodiment 29, wherein the unique wallet identifier's source is a source mobile user device with access to a user's source wallet associated with the unique wallet identifier.
45. The apparatus of embodiment 38, wherein the fields include a transaction amount.
46. The apparatus of embodiment 38, wherein the fields include a transaction item.
47. The apparatus of embodiment 29, wherein the beacon may be integral to a device.
48. The apparatus of embodiment 47, wherein the integration may be through a smart device having a processor and wireless communication.
49. The apparatus of embodiment 47, wherein the integration may be by affixing a beacon to the device.
50. The apparatus of embodiment 47, wherein the beacon may be affixed to a utility meter.
51. The apparatus of embodiment 47, wherein the beacon affixed to a utility meter may be read by a user.
52. The apparatus of embodiment 47, wherein the beacon affixed to a utility meter may be read by a user and outstanding usage may be paid by the user.
53. The apparatus of embodiment 47, wherein the beacon affixed to a utility meter is a refrigerator at a hotel, and usage metrics include items consumed by the user.
54. The apparatus of embodiment 47, wherein the beacon affixed to a utility meter is a thermostat at a hotel, and usage metrics include items consumed by the user.
55. The apparatus of embodiment 47, wherein the beacon affixed to a utility meter is a television at a hotel, and usage metrics include items viewed by the user.
56. The apparatus of embodiment 47, wherein the beacon affixed to a utility meter is a button affixed to consumables at a hotel, and usage metrics include items consumed by the user.
57. A processor-readable point-to-point payment guidance non-transient medium storing processor-executable components, the components, comprising:
a component collection stored in the medium, including:
   a point-to-point guidance component;
   wherein the component collection, stored in the medium, includes processor-issuable instructions to:
      obtain a target wallet identifier registration at a beacon;
      register the target wallet identifier with the beacon;
      obtain a unique wallet identifier from a wallet source associated with a user at the beacon;
      obtain a target transaction request at the beacon from the wallet source;
      commit the target transaction request for the amount specified in the target transaction request to a distributed block chain database configured to propagate the target transaction request across a distributed block chain database network for payment targeted to the target wallet identifier registered at the beacon.
58. The processor-readable point-to-point payment guidance non-transient medium of embodiment 57, wherein the beacon is registered to an organization.
59. The processor-readable point-to-point payment guidance non-transient medium of embodiment 58, wherein the target wallet identifier is of an employee of the organization.
60. The processor-readable point-to-point payment guidance non-transient medium of embodiment 59, further, comprising:
   instructions to verify the target wallet identifier is associated with the organization.
61. The processor-readable point-to-point payment guidance non-transient medium of embodiment 60, wherein the verification includes identifying the target wallet identifier exists in the organization's database.
62. The processor-readable point-to-point payment guidance non-transient medium of embodiment 60, wherein the verification includes authentication credentials.
63. The processor-readable point-to-point payment guidance non-transient medium of embodiment 62, wherein the authentication credentials are digitally signed.
64. The processor-readable point-to-point payment guidance non-transient medium of embodiment 62, wherein the authentication credentials are encrypted.
65. The processor-readable point-to-point payment guidance non-transient medium of embodiment 60, wherein the registration of the target wallet occurs upon the verification.
66. The processor-readable point-to-point payment guidance non-transient medium of embodiment 57, wherein the target transaction request includes a number of additional fields specified in an 80 byte transaction payload.
67. The processor-readable point-to-point payment guidance non-transient medium of embodiment 66, wherein the fields include a tip amount.
68. The processor-readable point-to-point payment guidance non-transient medium of embodiment 66, wherein the fields include the beacon's unique identifier.
69. The processor-readable point-to-point payment guidance non-transient medium of embodiment 66, wherein the fields include the target wallet identifier.
70. The processor-readable point-to-point payment guidance non-transient medium of embodiment 66, wherein the fields include the user's identification information.
71. The processor-readable point-to-point payment guidance non-transient medium of embodiment 57, wherein the beacon is a target mobile user device with access to a target user's target wallet associated with the target wallet identifier.
72. The processor-readable point-to-point payment guidance non-transient medium of embodiment 57, wherein the unique wallet identifier's source is a source mobile user device with access to a user's source wallet associated with the unique wallet identifier.
73. The processor-readable point-to-point payment guidance non-transient medium of embodiment 66, wherein the fields include a transaction amount.
74. The processor-readable point-to-point payment guidance non-transient medium of embodiment 66, wherein the fields include a transaction item.
75. The processor-readable point-to-point payment guidance non-transient medium of embodiment 57, wherein the beacon may be integral to a device.
76. The processor-readable point-to-point payment guidance non-transient medium of embodiment 57, wherein the integration may be through a smart device having a processor and wireless communication.
77. The processor-readable point-to-point payment guidance non-transient medium of embodiment 57, wherein the integration may be by affixing a beacon to the device.
78. The processor-readable point-to-point payment guidance non-transient medium of embodiment 57, wherein the beacon may be affixed to a utility meter.
79. The processor-readable point-to-point payment guidance non-transient medium of embodiment 57, wherein the beacon affixed to a utility meter may be read by a user.
80. The processor-readable point-to-point payment guidance non-transient medium of embodiment 57, wherein the beacon affixed to a utility meter may be read by a user and outstanding usage may be paid by the user.
81. The processor-readable point-to-point payment guidance non-transient medium of embodiment 57, wherein the beacon affixed to a utility meter is a refrigerator at a hotel, and usage metrics include items consumed by the user.
82. The processor-readable point-to-point payment guidance non-transient medium of embodiment 57, wherein the beacon affixed to a utility meter is a thermostat at a hotel, and usage metrics include items consumed by the user.
83. The processor-readable point-to-point payment guidance non-transient medium of embodiment 57, wherein the beacon affixed to a utility meter is a television at a hotel, and usage metrics include items viewed by the user.
84. The processor-readable point-to-point payment guidance non-transient medium of embodiment 57, wherein the beacon affixed to a utility meter is a button affixed to consumables at a hotel, and usage metrics include items consumed by the user.
85. A processor-implemented point-to-point payment guidance method, comprising: executing processor-implemented point-to-point guidance component instructions to:
   obtain a target wallet identifier registration at a beacon;
   register the target wallet identifier with the beacon;
   obtain a unique wallet identifier from a wallet source associated with a user at the beacon;
   obtain a target transaction request at the beacon from the migrant wallet source;
   commit the target transaction request for the amount specified in the target transaction request to a distributed block chain database configured to propagate the target transaction request across a distributed block chain database network for payment targeted to the target wallet identifier registered at the beacon.
86. The processor-implemented point-to-point payment guidance method of embodiment 85, wherein the beacon is registered to an organization.
87. The processor-implemented point-to-point payment guidance method of embodiment 85, wherein the target wallet identifier is of an employee of the organization.
88. The processor-implemented point-to-point payment guidance method of embodiment 85, further comprising:
   instructions to verify the target wallet identifier is associated with the organization.
89. The processor-implemented point-to-point payment guidance method of embodiment 88, wherein the verification includes identifying the target wallet identifier exists in the organization's database.
90. The processor-implemented point-to-point payment guidance method of embodiment 88, wherein the verification includes authentication credentials.
91. The processor-implemented point-to-point payment guidance method of embodiment 90, wherein the authentication credentials are digitally signed.
92. The processor-implemented point-to-point payment guidance method of embodiment 90, wherein the authentication credentials are encrypted.
93. The processor-implemented point-to-point payment guidance method of embodiment 90, wherein the registration of the target wallet occurs upon the verification.
94. The processor-implemented point-to-point payment guidance method of embodiment 88, wherein the target transaction request includes a number of additional fields specified in an 80 byte transaction payload.
95. The processor-implemented point-to-point payment guidance method of embodiment 94, wherein the fields include a tip amount.
96. The processor-implemented point-to-point payment guidance method of embodiment 94, wherein the fields include the beacon's unique identifier.
97. The processor-implemented point-to-point payment guidance method of embodiment 94, wherein the fields include the target wallet identifier.
98. The processor-implemented point-to-point payment guidance method of embodiment 94, wherein the fields include the user's identification information.
99. The processor-implemented point-to-point payment guidance method of embodiment 94, wherein the beacon is a target mobile user device with access to a target user's target wallet associated with the target wallet identifier.
100. The processor-implemented point-to-point payment guidance method of embodiment 94, wherein the unique wallet identifier's source is a source mobile user device with access to a user's source wallet associated with the unique wallet identifier.
101. The processor-implemented point-to-point payment guidance method of embodiment 94, wherein the fields include a transaction amount.
102. The processor-implemented point-to-point payment guidance method of embodiment 94, wherein the fields include a transaction item.
103. The processor-implemented point-to-point payment guidance method of embodiment 94, wherein the beacon may be integral to a device.
104. The processor-implemented point-to-point payment guidance method of embodiment 94, wherein the integration may be through a smart device having a processor and wireless communication.
105. The processor-implemented point-to-point payment guidance method of embodiment 94, wherein the integration may be by affixing a beacon to the device.
106. The processor-implemented point-to-point payment guidance method of embodiment 94, wherein the beacon may be affixed to a utility meter.
107. The processor-implemented point-to-point payment guidance method of embodiment 94, wherein the beacon affixed to a utility meter may be read by a user.
108. The processor-implemented point-to-point payment guidance method of embodiment 94, wherein the beacon affixed to a utility meter may be read by a user and outstanding usage may be paid by the user.
109. The processor-implemented point-to-point payment guidance method of embodiment 94, wherein the beacon affixed to a utility meter is a refrigerator at a hotel, and usage metrics include items consumed by the user.
110. The processor-implemented point-to-point payment guidance method of embodiment 94, wherein the beacon affixed to a utility meter is a thermostat at a hotel, and usage metrics include items consumed by the user.
111. The processor-implemented point-to-point payment guidance method of embodiment 94, wherein the beacon affixed to a utility meter is a television at a hotel, and usage metrics include items viewed by the user.
112. The processor-implemented point-to-point payment guidance method of embodiment 94, wherein the beacon affixed to a utility meter is a button affixed to consumables at a hotel, and usage metrics include items consumed by the user.
113. A processor-implemented point-to-point payment guidance system, comprising:
a point-to-point guidance component means, to:
   obtain a target wallet identifier registration at a beacon;
   register the target wallet identifier with the beacon;
   obtain a unique wallet identifier from a wallet source associated with a user at the beacon;
   obtain a target transaction request at the beacon from the wallet source;
   commit the target transaction request for the amount specified in the target transaction request to a distributed block chain database configured to propagate the target transaction request across a distributed block chain database network for payment targeted to the target wallet identifier registered at the beacon.
114. The processor-implemented point-to-point payment guidance system of embodiment 113, wherein the beacon is registered to an organization.
115. The processor-implemented point-to-point payment guidance system of embodiment 113, wherein the target wallet identifier is of an employee of the organization.
116. The processor-implemented point-to-point payment guidance system 92, further comprising: instructions to verify the target wallet identifier is associated with the organization.
117. The processor-implemented point-to-point payment guidance system of embodiment 116, wherein the verification includes identifying the target wallet identifier exists in the organization's database.
118. The processor-implemented point-to-point payment guidance system of embodiment 116, wherein the verification includes authentication credentials.
119. The processor-implemented point-to-point payment guidance system of embodiment 116, wherein the authentication credentials are digitally signed.
120. The processor-implemented point-to-point payment guidance system of embodiment 116, wherein the authentication credentials are encrypted.
121. The processor-implemented point-to-point payment guidance system of embodiment 116, wherein the registration of the target wallet occurs upon the verification.
122. The processor-implemented point-to-point payment guidance system of embodiment 116, wherein the target transaction request includes a number of additional fields specified in an 80 byte transaction payload.
123. The processor-implemented point-to-point payment guidance system of embodiment 122, wherein the fields include a tip amount.
124. The processor-implemented point-to-point payment guidance system of embodiment 122, wherein the fields include the beacon's unique identifier.
125. The processor-implemented point-to-point payment guidance system of embodiment 122, wherein the fields include the target wallet identifier.
126. The processor-implemented point-to-point payment guidance system of embodiment 122, wherein the fields include the user's identification information.
127. The processor-implemented point-to-point payment guidance system of embodiment 116, wherein the beacon is a target mobile user device with access to a target user's target wallet associated with the target wallet identifier.
128. The processor-implemented point-to-point payment guidance system of embodiment 116, wherein the unique wallet identifier's source is a source mobile user device with access to a user's source wallet associated with the unique wallet identifier.
129. The processor-implemented point-to-point payment guidance system of embodiment 116, wherein the fields include a transaction amount.
130. The processor-implemented point-to-point payment guidance system of embodiment 116, wherein the fields include a transaction item.
131. The processor-implemented point-to-point payment guidance system of embodiment 116, wherein the beacon is integral to a device.
132. The processor-implemented point-to-point payment guidance system of embodiment 116, wherein the integration may be through a smart device having a processor and wireless communication.
133. The processor-implemented point-to-point payment guidance system of embodiment 116, wherein the integration may be by affixing a beacon to the device.
134. The processor-implemented point-to-point payment guidance system of embodiment 116, wherein the beacon may be affixed to a utility meter.
135. The processor-implemented point-to-point payment guidance system of embodiment 116, wherein the beacon affixed to a utility meter may be read by a user.
136. The processor-implemented point-to-point payment guidance system of embodiment 116, wherein the beacon affixed to a utility meter may be read by a user and outstanding usage may be paid by the user.
137. The processor-implemented point-to-point payment guidance system of embodiment 116, wherein the beacon affixed to a utility meter is a refrigerator at a hotel, and usage metrics include items consumed by the user.
138. The processor-implemented point-to-point payment guidance system of embodiment 116, wherein the beacon affixed to a utility meter is a thermostat at a hotel, and usage metrics include items consumed by the user.
139. The processor-implemented point-to-point payment guidance system of embodiment 116, wherein the beacon affixed to a utility meter is a television at a hotel, and usage metrics include items viewed by the user.
140. The processor-implemented point-to-point payment guidance system of embodiment 116, wherein the beacon affixed to a utility meter is a button affixed to consumables, and usage metrics include items consumed by the user.
141. A point-to-point payment guidance apparatus, comprising:
a component collection stored in the medium, including:
a memory;
a component collection in any of memory and communication, including:
   a point-to-point guidance component;
a processor disposed in communication with the memory, and configured to issue a plurality of processing instructions from the component collection stored in the memory,
wherein a processor issues instructions from the component collection, stored in the memory, to obtain a payment source wallet identifier associated with a user at a beacon integrated with a product used by the user, which product periodically requires replenishment;
   register the payment source wallet identifier with the beacon;
   monitor a use or consumption of the product;
   when a use or consumption reaches a threshold level, transmit an order for a replenishment of the product to a supplier of the product; and
   transmit a destination address for the supplier to receive a payment from the payment source wallet identifier for the replenishment of the product to a distributed blockchain database configured to propagate the transaction request to a distributed blockchain database network for payment targeted to the destination address provided by the beacon.
142. The apparatus of embodiment 141, wherein the payment source wallet identifier includes a plurality of source addresses of the user, and wherein the user may select one or
143. The apparatus of embodiment 141, wherein the transaction request includes a number of additional fields specified in an 80 byte transaction payload.
144. The apparatus of embodiment 143, wherein the additional fields store at least one of public key or a hash of the public key of the user.
145. The apparatus of embodiment 144, wherein the fields include data that may be queried by the user using the public key to confirm the transaction request and payment amount.
146. The apparatus of embodiment 143, wherein the fields include a unique identifier of the beacon.
147. The apparatus of embodiment 143, wherein the fields include the target wallet identifier.
148. The apparatus of embodiment 143, wherein the fields include the user's identification information.
149. The apparatus of embodiment 143, wherein the fields include a transaction amount.
150. The apparatus of embodiment 66, wherein the fields include a micropayment amount.
151. The apparatus of embodiment 141, wherein the beacon is integrated with the product
152. The apparatus of embodiment 141, wherein the beacon is separate from the product
153. The apparatus of embodiment 141, wherein the integration may be by affixing a beacon to the product.
154. A processor-readable point-to-point payment guidance non-transient medium storing processor-executable components, the components, comprising:
a component collection stored in the medium, including:
   a point-to-point guidance component;
   wherein the component collection, stored in the medium, includes processor-issuable instructions to:
      obtain a payment source wallet identifier associated with a user at a beacon integrated with a product used by the user, which product periodically requires replenishment;
      register the payment source wallet identifier with the beacon;
      monitor a use or consumption of the product;
      when a use or consumption reaches a threshold level, transmit an order for a replenishment of the product to a supplier of the product; and
      transmit a destination address for the supplier to receive a payment from the payment source wallet identifier for the replenishment of the product to a distributed blockchain database configured to propagate the transaction request to a distributed blockchain database network for payment targeted to the destination address provided by the beacon.
155. The processor-readable point-to-point payment guidance non-transient medium of embodiment 154, wherein the payment source wallet identifier includes a plurality of source addresses of the user, and wherein the user may select one or more sources addresses from which to provide a payment.
156. The processor-readable point-to-point payment guidance non-transient medium of embodiment 154, wherein the transaction request includes a number of additional fields specified in an 80 byte transaction payload.
157. The processor-readable point-to-point payment guidance non-transient medium of embodiment 156, wherein the additional fields store at least one of public key or a hash of the public key of the user.
158. The processor-readable point-to-point payment guidance non-transient medium of embodiment 157, wherein the fields include data that may be queried by the user using the public key to confirm the transaction request and payment amount.
159. The processor-readable point-to-point payment guidance non-transient medium of embodiment 156, wherein the fields include a unique identifier of the beacon.
160. The processor-readable point-to-point payment guidance non-transient medium of embodiment 156, wherein the fields include the target wallet identifier.
161. The processor-readable point-to-point payment guidance non-transient medium of embodiment 156, wherein the fields include the user's identification information.
162. The processor-readable point-to-point payment guidance non-transient medium of embodiment 156, wherein the fields include a transaction amount
163. The processor-readable point-to-point payment guidance non-transient medium of embodiment 66, wherein the fields include a micropayment amount.
164. The processor-readable point-to-point payment guidance non-transient medium of embodiment 154, wherein the beacon is integrated with the product
165. The processor-readable point-to-point payment guidance non-transient medium of embodiment 154, wherein the beacon is separate from the product
166. The processor-readable point-to-point payment guidance non-transient medium of embodiment 154, wherein the integration may be by affixing a beacon to the product.
167. A point-to-point payment guidance method, comprising:
   obtaining a payment source wallet identifier associated with a user at a beacon integrated with a product used by the user, which product periodically requires replenishment;
   registering the payment source wallet identifier with the beacon;
   monitoring a use or consumption of the product;
   when a use or consumption reaches a threshold level, transmitting an order for a replenishment of the product to a supplier of the product; and
   transmitting a destination address for the supplier to receive a payment from the payment source wallet identifier for the replenishment of the product to a distributed blockchain database configured to propagate the transaction request to a distributed blockchain database network for payment targeted to the destination address provided by the beacon.
168. The method of embodiment 167, wherein the payment source wallet identifier includes a plurality of source addresses of the user, and wherein the user may select one or more sources addresses from which to provide a payment.
169. The method of embodiment 167, wherein the transaction request includes a number of additional fields specified in an 80 byte transaction payload.
170. The method of embodiment 169, wherein the additional fields store at least one of public key or a hash of the public key of the user.
171. The method of embodiment 170, wherein the fields include data that may be queried by the user using the public key to confirm the transaction request and payment amount.
172. The method of embodiment 169, wherein the fields include a unique identifier of the beacon.
173. The method of embodiment 169, wherein the fields include the target wallet identifier.
174. The method of embodiment 169, wherein the fields include the user's identification information.
175. The method of embodiment 169, wherein the fields include a transaction amount.
176. The method of embodiment 169, wherein the fields include a micropayment amount.
177. The method of embodiment 167, wherein the beacon is integrated with the product
178. The method of embodiment 167, wherein the beacon is separate from the product
179. The method of embodiment 167, wherein the integration may be by affixing a beacon to the product.
180. A point-to-point payment guidance system, comprising:
   means for obtaining a payment source wallet identifier associated with a user at a beacon integrated with a product used by the user, which product periodically requires replenishment;
   means for registering the payment source wallet identifier with the beacon;
   means for monitoring a use or consumption of the product;
   means for transmitting an order for a replenishment of the product to a supplier of the product when a use or consumption reaches a threshold level; and
   means for transmitting a destination address for the supplier to receive a payment from the payment source wallet identifier for the replenishment of the product to a distributed blockchain database configured to propagate the transaction request to a distributed blockchain database network for payment targeted to the destination address provided by the beacon.
181. The system of embodiment 180, wherein the payment source wallet identifier includes a plurality of source addresses of the user, and wherein the user may select one or more sources addresses from which to provide a payment.
182. The system of embodiment 180, wherein the transaction request includes a number of additional fields specified in an 80 byte transaction payload.
183. The system of embodiment 182, wherein the additional fields store at least one of public key or a hash of the public key of the user.
184. The system of embodiment 183, wherein the fields include data that may be queried by the user using the public key to confirm the transaction request and payment amount.
185. The system of embodiment 182, wherein the fields include a unique identifier of the beacon.
186. The system of embodiment 182, wherein the fields include the target wallet identifier.
187. The system of embodiment 182, wherein the fields include the user's identification information.
188. The system of embodiment 182, wherein the fields include a transaction amount.
189. The system of embodiment 182, wherein the fields include a micropayment amount.
190. The system of embodiment 180, wherein the beacon is integrated with the product.
191. The system of embodiment 180, wherein the beacon is separate from the product.
192. The system of embodiment 180, wherein the integration may be by affixing a beacon to the product.

In order to address various issues and advance the art, the entirety of this application for Point-to-Point Transaction Guidance Apparatuses, Methods and Systems (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components, data flow order, logic flow order, and/or any present feature sets as described in the figures and/or throughout are not limited to a fixed operating order and/or arrangement, but rather, any disclosed order is exemplary and all equivalents, regardless of order, are contemplated by the disclosure. Similarly, descriptions of embodiments disclosed throughout this disclosure, any reference to direction or orientation is merely intended for convenience of description and is not intended in any way to limit the scope of described embodiments. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should not be construed to limit embodiments, and instead, again, are offered for convenience of description of orientation. These relative descriptors are for convenience of description only and do not require that any embodiments be constructed or operated in a particular orientation unless explicitly indicated as such. Terms such as “attached,” “affixed,” “connected,” “coupled,” “interconnected,” and similar may refer to a relationship wherein structures are secured or attached to one another either directly or indirectly through intervening structures, as well as both movable or rigid attachments or relationships, unless expressly described otherwise. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a individual and/or enterprise user, database configuration and/or relational model, data type, data transmission and/or network framework, syntax structure, and/or the like, various embodiments of the P2PTG, may be implemented that enable a great deal of flexibility and customization. For example, aspects of the may be adapted for monetary and non-monetary transactions. While various embodiments and discussions of the have included Guided Target Transactions, however, it is to be understood that the embodiments described herein may be readily configured and/or customized for a wide variety of other applications and/or implementations.

What is claimed is:

1. A point-to-point payment guidance apparatus, comprising:
a memory;
a component collection in any of memory and communication, including:
a point-to-point guidance component;
a processor disposed in communication with the memory, and configured to issue a plurality of processing instructions from the component collection stored in the memory,
wherein a processor issues instructions from the point-to-point guidance component, stored in the memory, to:
obtain a target wallet identifier registration at a beacon;
register the target wallet identifier with the beacon;
obtain a unique wallet identifier from a migrant wallet source associated with a user at the beacon;
obtain a target transaction request at the beacon from the migrant wallet source;
commit the target transaction request for the amount specified in the target transaction request to a distributed block chain database configured to propagate the target transaction request across a distributed block chain database network for payment targeted to the target wallet identifier registered at the beacon.

2. The apparatus of claim 1, wherein the beacon is registered to an organization.

3. The apparatus of claim 2, wherein the target wallet identifier is of an employee of the organization.

4. The apparatus of claim 3, further, comprising:
verify the target wallet identifier is associated with the organization.

5. The apparatus of claim 4, wherein the verification includes identifying the target wallet identifier exists in the organization's database.

6. The apparatus of claim 4, wherein the verification includes authentication credentials.

7. The apparatus of claim 6, wherein the authentication credentials are digitally signed.

8. The apparatus of claim 6, wherein the authentication credentials are encrypted.

9. The apparatus of claim 6, wherein the registration of the target wallet occurs upon the verification.

10. The apparatus of claim 1, wherein the target transaction request includes a number of additional fields specified in an 80 byte transaction payload.

11. The apparatus of claim 10, wherein the fields include a tip amount.

12. The apparatus of claim 10, wherein the fields include the beacon's unique identifier.

13. The apparatus of claim 10, wherein the fields include the target wallet identifier.

14. The apparatus of claim 10, wherein the fields include the user's identification information.

15. The apparatus of claim 1, wherein the beacon is a target mobile user device with access to a target user's target wallet associated with the target wallet identifier.

16. The apparatus of claim 1, wherein the unique wallet identifier's source is a source mobile user device with access to a user's source wallet associated with the unique wallet identifier.

17. The apparatus of claim 10, wherein the fields include a transaction amount.

18. The apparatus of claim 10, wherein the fields include a transaction item.

19. The apparatus of claim 1, wherein the beacon may be integral to a device.

20. The apparatus of claim 19, wherein the integration may be through a smart device having a processor and wireless communication.

21. The apparatus of claim 19, wherein the integration may be by affixing a beacon to the device.

22. The apparatus of claim 19, wherein the beacon may be affixed to a utility meter.

23. The apparatus of claim 19, wherein the beacon affixed to a utility meter may be read by a user.

24. The apparatus of claim 19, wherein the beacon affixed to a utility meter may be read by a user and outstanding usage may be paid by the user.

25. The apparatus of claim 19, wherein the beacon affixed to a utility meter is a refrigerator at a hotel, and usage metrics include items consumed by the user.

26. The apparatus of claim 19, wherein the beacon affixed to a utility meter is a thermostat at a hotel, and usage metrics include items consumed by the user.

27. The apparatus of claim 19, wherein the beacon affixed to a utility meter is a television at a hotel, and usage metrics include items viewed by the user.

28. The apparatus of claim 19, wherein the beacon affixed to a utility meter is a button affixed to consumables at a hotel, and usage metrics include items consumed by the user.

29. A processor-readable point-to-point payment guidance non-transient medium storing processor-executable components, the components, comprising:
a component collection stored in the medium, including:
a point-to-point guidance component;
wherein the component collection, stored in the medium, includes processor-issuable instructions to:
obtain a target wallet identifier registration at a beacon;
register the target wallet identifier with the beacon;
obtain a unique wallet identifier from a wallet source associated with a user at the beacon;
obtain a target transaction request at the beacon from the wallet source;
commit the target transaction request for the amount specified in the target transaction request to a distributed block chain database configured to propagate the target transaction request across a distributed block chain database network for payment targeted to the target wallet identifier registered at the beacon.

30. The processor-readable point-to-point payment guidance non-transient medium of claim 29, wherein the beacon is registered to an organization.

31. The processor-readable point-to-point payment guidance non-transient medium of claim 30, wherein the target wallet identifier is of an employee of the organization.

32. The processor-readable point-to-point payment guidance non-transient medium of claim 31, further, comprising:
instructions to verify the target wallet identifier is associated with the organization.

33. The processor-readable point-to-point payment guidance non-transient medium of claim 32, wherein the verification includes identifying the target wallet identifier exists in the organization's database.

34. The processor-readable point-to-point payment guidance non-transient medium of claim 32, wherein the verification includes authentication credentials.

35. The processor-readable point-to-point payment guidance non-transient medium of claim 34, wherein the authentication credentials are digitally signed.

36. The processor-readable point-to-point payment guidance non-transient medium of claim 34, wherein the authentication credentials are encrypted.

37. The processor-readable point-to-point payment guidance non-transient medium of claim 32, wherein the registration of the target wallet occurs upon the verification.

38. The processor-readable point-to-point payment guidance non-transient medium of claim 29, wherein the target transaction request includes a number of additional fields specified in an 80 byte transaction payload.

39. The processor-readable point-to-point payment guidance non-transient medium of claim 38, wherein the fields include a tip amount.

40. The processor-readable point-to-point payment guidance non-transient medium of claim 38, wherein the fields include the beacon's unique identifier.

41. The processor-readable point-to-point payment guidance non-transient medium of claim 38, wherein the fields include the target wallet identifier.

42. The processor-readable point-to-point payment guidance non-transient medium of claim 38, wherein the fields include the user's identification information.

43. The processor-readable point-to-point payment guidance non-transient medium of claim 29, wherein the beacon is a target mobile user device with access to a target user's target wallet associated with the target wallet identifier.

44. The processor-readable point-to-point payment guidance non-transient medium of claim 29, wherein the unique wallet identifier's source is a source mobile user device with access to a user's source wallet associated with the unique wallet identifier.

45. The processor-readable point-to-point payment guidance non-transient medium of claim 38, wherein the fields include a transaction amount.

46. The processor-readable point-to-point payment guidance non-transient medium of claim 38, wherein the fields include a transaction item.

47. The processor-readable point-to-point payment guidance non-transient medium of claim 29, wherein the beacon may be integral to a device.

48. The processor-readable point-to-point payment guidance non-transient medium of claim 29, wherein the integration may be through a smart device having a processor and wireless communication.

49. The processor-readable point-to-point payment guidance non-transient medium of claim 29, wherein the integration may be by affixing a beacon to the device.

50. The processor-readable point-to-point payment guidance non-transient medium of claim 29, wherein the beacon may be affixed to a utility meter.

51. The processor-readable point-to-point payment guidance non-transient medium of claim 29, wherein the beacon affixed to a utility meter may be read by a user.

52. The processor-readable point-to-point payment guidance non-transient medium of claim 29, wherein the beacon affixed to a utility meter may be read by a user and outstanding usage may be paid by the user.

53. The processor-readable point-to-point payment guidance non-transient medium of claim 29, wherein the beacon affixed to a utility meter is a refrigerator at a hotel, and usage metrics include items consumed by the user.

54. The processor-readable point-to-point payment guidance non-transient medium of claim 29, wherein the beacon affixed to a utility meter is a thermostat at a hotel, and usage metrics include items consumed by the user.

55. The processor-readable point-to-point payment guidance non-transient medium of claim 29, wherein the beacon affixed to a utility meter is a television at a hotel, and usage metrics include items viewed by the user.

56. The processor-readable point-to-point payment guidance non-transient medium of claim 29, wherein the beacon affixed to a utility meter is a button affixed to consumables at a hotel, and usage metrics include items consumed by the user.

57. A processor-implemented point-to-point payment guidance method, comprising:
executing processor-implemented point-to-point guidance component instructions to:
obtain a target wallet identifier registration at a beacon;
register the target wallet identifier with the beacon;
obtain a unique wallet identifier from a wallet source associated with a user at the beacon;
obtain a target transaction request at the beacon from the migrant wallet source;
commit the target transaction request for the amount specified in the target transaction request to a distributed block chain database configured to propagate the target transaction request across a distributed block chain database network for payment targeted to the target wallet identifier registered at the beacon.

58. The processor-implemented point-to-point payment guidance method of claim 57, wherein the beacon is registered to an organization.

59. The processor-implemented point-to-point payment guidance method of claim 57, wherein the target wallet identifier is of an employee of the organization.

60. The processor-implemented point-to-point payment guidance method of claim 57, further comprising:
instructions to verify the target wallet identifier is associated with the organization.

61. The processor-implemented point-to-point payment guidance method of claim 60, wherein the verification includes identifying the target wallet identifier exists in the organization's database.

62. The processor-implemented point-to-point payment guidance method of claim 60, wherein the verification includes authentication credentials.

63. The processor-implemented point-to-point payment guidance method of claim 62, wherein the authentication credentials are digitally signed.

64. The processor-implemented point-to-point payment guidance method of claim 62, wherein the authentication credentials are encrypted.

65. The processor-implemented point-to-point payment guidance method of claim 62, wherein the registration of the target wallet occurs upon the verification.

66. The processor-implemented point-to-point payment guidance method of claim 60, wherein the target transaction request includes a number of additional fields specified in an 80 byte transaction payload.

67. The processor-implemented point-to-point payment guidance method of claim 66, wherein the fields include a tip amount.

68. The processor-implemented point-to-point payment guidance method of claim 66, wherein the fields include the beacon's unique identifier.

69. The processor-implemented point-to-point payment guidance method of claim 66, wherein the fields include the target wallet identifier.

70. The processor-implemented point-to-point payment guidance method of claim 66, wherein the fields include the user's identification information.

71. The processor-implemented point-to-point payment guidance method of claim 66, wherein the beacon is a target mobile user device with access to a target user's target wallet associated with the target wallet identifier.

72. The processor-implemented point-to-point payment guidance method of claim 66, wherein the unique wallet identifier's source is a source mobile user device with access to a user's source wallet associated with the unique wallet identifier.

73. The processor-implemented point-to-point payment guidance method of claim 66, wherein the fields include a transaction amount.

74. The processor-implemented point-to-point payment guidance method of claim 66, wherein the fields include a transaction item.

75. The processor-implemented point-to-point payment guidance method of claim 66, wherein the beacon may be integral to a device.

76. The processor-implemented point-to-point payment guidance method of claim 66, wherein the integration may be through a smart device having a processor and wireless communication.

77. The processor-implemented point-to-point payment guidance method of claim 66, wherein the integration may be by affixing a beacon to the device.

78. The processor-implemented point-to-point payment guidance method of claim 66, wherein the beacon may be affixed to a utility meter.

79. The processor-implemented point-to-point payment guidance method of claim 66, wherein the beacon affixed to a utility meter may be read by a user.

80. The processor-implemented point-to-point payment guidance method of claim 66, wherein the beacon affixed to a utility meter may be read by a user and outstanding usage may be paid by the user.

81. The processor-implemented point-to-point payment guidance method of claim 66, wherein the beacon affixed to a utility meter is a refrigerator at a hotel, and usage metrics include items consumed by the user.

82. The processor-implemented point-to-point payment guidance method of claim 66, wherein the beacon affixed to a utility meter is a thermostat at a hotel, and usage metrics include items consumed by the user.

83. The processor-implemented point-to-point payment guidance method of claim 66, wherein the beacon affixed to a utility meter is a television at a hotel, and usage metrics include items viewed by the user.

84. The processor-implemented point-to-point payment guidance method of claim 66, wherein the beacon affixed to a utility meter is a button affixed to consumables at a hotel, and usage metrics include items consumed by the user.

85. A processor-implemented point-to-point payment guidance system, comprising:
a point-to-point guidance component means, to:
obtain a target wallet identifier registration at a beacon;
register the target wallet identifier with the beacon;
obtain a unique wallet identifier from a wallet source associated with a user at the beacon;
obtain a target transaction request at the beacon from the wallet source;
commit the target transaction request for the amount specified in the target transaction request to a distributed block chain database configured to propagate the target transaction request across a distributed block chain database network for payment targeted to the target wallet identifier registered at the beacon.

86. The processor-implemented point-to-point payment guidance system of claim 85, wherein the beacon is registered to an organization.

87. The processor-implemented point-to-point payment guidance system of claim 85, wherein the target wallet identifier is of an employee of the organization.

88. The processor-implemented point-to-point payment guidance system 92, further comprising:
instructions to verify the target wallet identifier is associated with the organization.

89. The processor-implemented point-to-point payment guidance system of claim 88, wherein the verification includes identifying the target wallet identifier exists in the organization's database.

90. The processor-implemented point-to-point payment guidance system of claim 88, wherein the verification includes authentication credentials.

91. The processor-implemented point-to-point payment guidance system of claim 88, wherein the authentication credentials are digitally signed.

92. The processor-implemented point-to-point payment guidance system of claim 88, wherein the authentication credentials are encrypted.

93. The processor-implemented point-to-point payment guidance system of claim 88, wherein the registration of the target wallet occurs upon the verification.

94. The processor-implemented point-to-point payment guidance system of claim 88, wherein the target transaction request includes a number of additional fields specified in an 80 byte transaction payload.

95. The processor-implemented point-to-point payment guidance system of claim 94, wherein the fields include a tip amount.

96. The processor-implemented point-to-point payment guidance system of claim 94, wherein the fields include the beacon's unique identifier.

97. The processor-implemented point-to-point payment guidance system of claim 94, wherein the fields include the target wallet identifier.

98. The processor-implemented point-to-point payment guidance system of claim 94, wherein the fields include the user's identification information.

99. The processor-implemented point-to-point payment guidance system of claim 88, wherein the beacon is a target mobile user device with access to a target user's target wallet associated with the target wallet identifier.

100. The processor-implemented point-to-point payment guidance system of claim 88, wherein the unique wallet identifier's source is a source mobile user device with access to a user's source wallet associated with the unique wallet identifier.

101. The processor-implemented point-to-point payment guidance system of claim 88, wherein the fields include a transaction amount.

102. The processor-implemented point-to-point payment guidance system of claim 88, wherein the fields include a transaction item.

103. The processor-implemented point-to-point payment guidance system of claim 88, wherein the beacon is integral to a device.

104. The processor-implemented point-to-point payment guidance system of claim 88, wherein the integration may be through a smart device having a processor and wireless communication.

105. The processor-implemented point-to-point payment guidance system of claim 88, wherein the integration may be by affixing a beacon to the device.

106. The processor-implemented point-to-point payment guidance system of claim 88, wherein the beacon may be affixed to a utility meter.

107. The processor-implemented point-to-point payment guidance system of claim 88, wherein the beacon affixed to a utility meter may be read by a user.

108. The processor-implemented point-to-point payment guidance system of claim 88, wherein the beacon affixed to a utility meter may be read by a user and outstanding usage may be paid by the user.

109. The processor-implemented point-to-point payment guidance system of claim 88, wherein the beacon affixed to a utility meter is a refrigerator at a hotel, and usage metrics include items consumed by the user.

110. The processor-implemented point-to-point payment guidance system of claim 88, wherein the beacon affixed to a utility meter is a thermostat at a hotel, and usage metrics include items consumed by the user.

111. The processor-implemented point-to-point payment guidance system of claim 88, wherein the beacon affixed to a utility meter is a television at a hotel, and usage metrics include items viewed by the user.

112. The processor-implemented point-to-point payment guidance system of claim 88, wherein the beacon affixed to a utility meter is a button affixed to consumables, and usage metrics include items consumed by the user.
